(19) United States
(12) Patent Application Publication
(10) Pub. No.: US 2025/0218050 A1
(43) Pub. Date: Jul. 3, 2025

(54) FILTERING FOR VIDEO ENCODING AND DECODING

(71) Applicant: Telefonaktiebolaget LM Ericsson (publ), Stockholm (SE)

(72) Inventors: Yun LI, Lund (SE); Jacob STRÖM, Stockholm (SE); Du LIU, Solna (SE); Per WENNERSTEN, Årsta (SE); Mitra DAMGHANIAN, Upplands-Bro (SE)

(21) Appl. No.: 18/880,617

(22) PCT Filed: Jul. 5, 2023
(86) PCT No.: PCT/EP2023/068592

§ 371 Date: Jan. 2, 2025

Related U.S. Application Data
(60) Provisional application No. 63/358,253, filed on Jul. 5, 2022.

(51) Int. Cl. G06T 9/00; H04N 19/82

(52) U.S. Cl. CPC G06T 9/002; H04N 19/82

(57) ABSTRACT

There is provided a method of generating encoded video data or decoded video data. The method comprises providing input data to a first convolution layer, CL, thereby generating first convoluted data, generating residual data based on the first convoluted data, and generating the encoded video data or the decoded video data based on a combination of the input data and the residual data.

### TECHNICAL FIELD

This disclosure relates to methods and apparatus for performing filtering for video encoding and decoding.

### BACKGROUND

Video is the dominant form of data traffic in today's networks and is projected to continuously increase its share. One way to reduce the data traffic from video is compression. In the compression, the source video is encoded into a bitstream, which then can be stored and transmitted to end users. Using a decoder, the end user can extract the video data and display it on a screen.

However, since the encoder does not know what kind of device the encoded bitstream is going to be sent to, the encoder must compress the video into a standardized format. Then all devices that support the chosen standard can successfully decode the video. Compression can be lossless, i.e., the decoded video will be identical to the source video that was given to the encoder, or lossy, where a certain degradation of content is accepted. Whether the compression is lossless or lossy has a significant impact on the bitrate, i.e., how high the compression ratio is, as factors such as noise can make lossless compression quite expensive.

A video sequence contains a sequence of pictures. A color space commonly used in video sequences is YCbCr, where Y is the luma (brightness) component, and Cb and Cr are the chroma components. Sometimes the Cb and Cr components are called U and V. Other color spaces are also used, such as ICtCp (a.k.a., IPT) (where I is the luma component, and Ct and Cp are the chroma components), constant-luminance YCbCr (where Y is the luma components, and Cb and Cr are the chroma components), RGB (where R, G, and B correspond to blue, green, and blue components respectively), YCoCg (where Y is the luma components, and Co and Cg are the chroma components), etc.

The order that the pictures are placed in the video sequence is called “display order.” Each picture is assigned with a Picture Order Count (POC) value to indicate its display order. In this disclosure, the terms “images,” “pictures” or “frames” are used interchangeably.

Video compression is used to compress video sequences into a sequence of coded pictures. In many existing video codecs, the picture is divided into blocks of different sizes. A block is a two-dimensional array of samples. The blocks serve as the basis for coding. A video decoder then decodes the coded pictures into pictures containing sample values.

Video standards are usually developed by international organizations as these represent different companies and research institutes with different areas of expertise and interests. The currently most applied video compression standard is H.264/AVC (Advanced Video Coding) which was jointly developed by ITU-T and ISO. The first version of H.264/AVC was finalized in 2003, with several updates in the following years. The successor of H.264/AVC, which was also developed by ITU-T (International Telecommunication Union-Telecommunication) and International Organization for Standardization (ISO), is known as H.265/HEVC (High Efficiency Video Coding) and was finalized in 2013. MPEG and ITU-T have created a successor to HEVC within the Joint Video Exploratory Team (JVET). The name of this video codec is Versatile Video Coding (VVC) and version 1 of the VVC specification has been published as Rec. ITU-T H.266|ISO/IEC (International Electrotechnical Commission) 23090-3, “Versatile Video Coding”, 2020.

The VVC video coding standard is a block-based video codec and utilizes both temporal and spatial prediction. Spatial prediction is achieved using intra (I) prediction from within the current picture. Temporal prediction is achieved using uni-directional (P) or bi-directional inter (B) prediction at the block level from previously decoded reference pictures. In the encoder, the difference between the original sample data and the predicted sample data, referred to as the residual, is transformed into the frequency domain, quantized, and then entropy coded before being transmitted together with necessary prediction parameters such as prediction mode and motion vectors (which may also be entropy coded). The decoder performs entropy decoding, inverse quantization, and inverse transformation to obtain the residual, and then adds the residual to the intra or inter prediction to reconstruct a picture.

The VVC video coding standard uses a block structure referred to as quadtree plus binary tree plus ternary tree block structure (QTBT+TT), where each picture is first partitioned into square blocks called coding tree units (CTU). All CTUs are of the same size and the partitioning of the picture into CTUs is done without any syntax controlling it.

Each CTU is further partitioned into coding units (CUs) that can have either square or rectangular shapes. The CTU is first partitioned by a quad tree structure, then it may be further partitioned with equally sized partitions either vertically or horizontally in a binary structure to form coding units (CUs). A block could thus have either a square or rectangular shape. The depth of the quad tree and binary tree can be set by the encoder in the bitstream. The ternary tree (TT) part adds the possibility to divide a CU into three partitions instead of two equally sized partitions. This increases the possibilities to use a block structure that better fits the content structure of a picture, such as roughly following important edges in the picture.

A block that is intra coded is an I-block. A block that is uni-directional predicted is a P-block and a block that is bi-directional predicted a B-block. For some blocks, the encoder decides that encoding the residual is not necessary, perhaps because the prediction is sufficiently close to the original. The encoder then signals to the decoder that the transform coding of that block should be bypassed, i.e., skipped. Such a block is referred to as a skip-block.

At the 20^{th} JVET meeting, it was decided to setup an exploration experiment (EE) on neural network-based (NN-based) video coding. The exploration experiment continued at the 21^{st} and 22^{nd} JVET meetings with two EE tests: NN-based filtering and NN-based super resolution. In the 23^{rd} JVET meeting, the test was decided to be continued in three categories: enhancement filters, super-resolution methods, and intra prediction. In the category of enhancement filters, two configurations were considered: (i) the proposed filter used as in-loop filter and (ii) the proposed filter used as a post-processing filter.

In-loop filtering in VVC includes deblocking filtering, sample adaptive offsets (SAO) operation, and adaptive loop filter (ALF) operation. The deblocking filter is used to remove block artifacts by smoothening discontinuities in horizontal and vertical directions across block boundaries. The deblocking filter uses a block boundary strength (BS) parameter to determine the filtering strength. The BS parameter can have values of 0, 1, and 2, where a larger value indicates a stronger filtering. The output of deblocking filter is further processed by SAO operation, and the output of the SAO operation is then processed by ALF operation. The output of the ALF can then be put into the display picture buffer (DPB), which is used for prediction of subsequently encoded (or decoded) pictures. Since the deblocking filter, the SAO filter, and the ALF influence the pictures in the DPB used for prediction, they are classified as in-loop filters, also known as loopfilters. It is possible for a decoder to further filter the image, but not send the filtered output to the DPB, but only to the display. In contrast to loopfilters, such a filter is not influencing future predictions and is therefore classified as a post-processing filter, also known as a postfilter.

The contributions JVET-X0066 described in EE1-1.6: Combined Test of EE1-1.2 and EE1-1.4, Y. Li, K. Zhang, L. Zhang, H. Wang, J. Chen, K. Reuze, A. M. Kotra, M. Karczewicz, JVET-X0066, October 2021 and JVET-Y0143 described in EE1-1.2: Test on Deep In-Loop Filter with Adaptive Parameter Selection and Residual Scaling, Y. Li, K. Zhang, L. Zhang, H. Wang, K. Reuze, A. M. Kotra, M. Karczewicz, JVET-Y0143, January 2022 are two successive contributions that describe NN-based in-loop filtering.

Both contributions use the same NN models for filtering. The NN-based in-loop filter is placed before SAO and ALF and the deblocking filter is turned off. The purpose of using the NN-based filter is to improve the quality of the reconstructed samples. The NN model may be non-linear. While all of deblocking filter, SAO, and ALF contain non-linear elements such as conditions, and thus are not strictly linear, all three of them are based on linear filters. A sufficiently big NN model in contrast can in principle learn any non-linear mapping and is therefore capable of representing a wider class of functions compared to deblocking, SAO and ALF.

In JVET-X0066 and JVET-Y0143, there are four NN models, i.e., four NN-based in-loop filters-one for luma intra samples, one for chroma intra samples, one for luma inter samples, and one for chroma inter samples. The use of NN filtering can be controlled on a block (CTU) level or a picture level. The encoder can determine whether to use NN filtering for each block or each picture.

This NN-based in-loop filter increases the compression efficiency of the codec substantially, i.e., it lowers the bit rate substantially without lowering the objective quality as measured by MSE (mean-square error)-based PSNR (peak signal-to-noise ratio). Increases in compression efficiency, or simply “gain”, is often measured as the Bjontegaard-delta rate (BDR) against an anchor. An example, a BDR of −1% means that the same PSNR can be reached with 1% fewer bits. As reported in JVET-Y0143, for the random access (RA) configuration, the BDR gain for the luma component (Y) is −9.80%, and for the all-intra (AI) configuration, the BDR gain for the luma component is −7.39%. The complexity of NN models used for compression is often measured by the number of Multiply-Accumulate (MAC) operations per pixel. The high gain of NN model is directly related to the high complexity of the NN model. The luma intra model described in JVET-Y0143 has a complexity of 430 kMAC/sample, i.e., 430000 multiply-accumulate operations per sample. Together with the multiply-accumulate operations needed for the chroma model (110 kMAC), the overall complexity becomes 540 kMAC/pixel. There are also other measures of complexity, such as total model size in terms of stored parameters.

### SUMMARY

However, the structure of the NN model described in JVET-Y0143 is not optimal. For example, the high complexity of the NN model can be a major challenge for practical hardware implementations. Therefore, reducing the complexity of the NN model while preserving or improving the performance of the NN model is therefore highly desirable.

Accordingly, in one aspect of the embodiments of this disclosure, there is provided a method for generating an encoded video or a decoded video. The method comprises obtaining values of reconstructed samples; obtaining input information comprising any one or a combination of: i) information about filtered samples, ii) information about predicted samples, or iii) information about skipped samples; providing the values of reconstructed samples and the input information to a machine learning, ML, model, thereby generating at least one ML output data; and based at least on said at least one ML output data, generating the encoded video or the decoded video.

In another aspect, there is provided a method for generating an encoded video or a decoded video. The method comprises obtaining machine learning, ML, input data, wherein the ML input data comprises: i) values of reconstructed samples; ii) values of predicted samples; iii) block boundary strength, BBS, information indicating strength of a filtering applied to a boundary of samples; and iv) quantization parameters, QP. The method further comprises providing the ML input data to a ML model, thereby generating ML output data; and based at least on the ML output data, generating the encoded video or the decoded video. The ML input data does not include partition information indicating how a luma picture is partitioned into coding tree units, CTUs, and how luma CTUs are partitioned into coding units, CUs.

In a different aspect, there is provided a method for generating an encoded video or a decoded video. The method comprises obtaining machine learning, ML, input data, wherein the ML input data comprises: i) values of reconstructed samples; ii) values of predicted samples; iii) quantization parameters, QP. The method further comprises providing the ML input data to a ML model, thereby generating ML output data; and based at least on the ML output data, generating the encoded video or the decoded video. The ML input data does not include block boundary strength, BBS, information indicating strength of a filtering applied to a boundary of samples.

In a different aspect, there is provided a method for generating an encoded video or a decoded video. The method comprises obtaining values of reconstructed samples; obtaining quantization parameters, QPs; providing the reconstructed sample values and the quantization parameters to a machine learning, ML, model, thereby generating ML output data; based at least on the ML output data, generating first output sample values; and providing the first output sample values to a group of two or more attention residual blocks connected in series. The group of attention residual blocks comprises a first attention residual block disposed at one end of the series of attention residual blocks, and the first attention residual block is configured to receive first input data consisting of the first output sample values, and generate second output sample values based on the first output sample values.

In a different aspect, there is provided a method for generating an encoded video or a decoded video. The method comprises obtaining machine learning, ML, input data. The ML input data comprises: i) values of luma components of reconstructed samples; ii) values of chroma components of reconstructed samples; iii) values of luma components of predicted samples; iv) values of chroma components of predicted samples; v) first block boundary strength, BBS, information indicating strength of a filtering applied to a boundary of luma components of samples; vi) second BBS information indicating strength of a filtering applied to a boundary of chroma components of samples; and iv) quantization parameters, QP. The method further comprises providing the ML input data to a ML model, thereby generating ML output data; and based at least on the ML output data, generating the encoded video or the decoded video.

In a different aspect, there is provided a method for generating an encoded video or a decoded video. The method comprises obtaining values of reconstructed samples; obtaining quantization parameters, QPs; providing the reconstructed sample values and the quantization parameters to a machine learning, ML, model, thereby generating ML output data; based at least on the ML output data, generating first output sample values; providing the first output sample values to a group of two or more attention residual blocks connected in series, thereby generating second output sample values; and generating the encoded video or the decoded video based on the second output sample values. The group of attention residual blocks comprises a first attention residual block disposed at one end of the series of attention residual blocks, and the first attention residual block is configured to receive input data consisting of the first output sample values and the QPs.

In a different aspect, there is provided a computer program comprising instructions (1244) which when executed by processing circuitry cause the processing circuitry to perform the method of any one of the embodiments described above.

In a different aspect, there is provided an apparatus for generating an encoded video or a decoded video. The apparatus is configured to obtain values of reconstructed samples; obtaining input information comprising any one or a combination of: i) information about filtered samples, ii) information about predicted samples, or iii) information about skipped samples; provide the values of reconstructed samples and the input information to a machine learning, ML, model, thereby generating at least one ML output data; and based at least on said at least one ML output data, generate the encoded video or the decoded video.

In a different aspect, there is provided an apparatus for generating an encoded video or a decoded video. The apparatus is configured to obtain machine learning, ML, input data, wherein the ML input data comprises: i) values of reconstructed samples; ii) values of predicted samples; iii) block boundary strength, BBS, information indicating strength of a filtering applied to a boundary of samples; and iv) quantization parameters, QP. The apparatus is configured to provide the ML input data to a ML model, thereby generating ML output data; and based at least on the ML output data, generate the encoded video or the decoded video. The ML input data does not include partition information indicating how a luma picture is partitioned into coding tree units, CTUs, and how luma CTUs are partitioned into coding units, CUs.

In a different aspect, there is provided an apparatus for generating an encoded video or a decoded video. The apparatus is configured to obtain machine learning, ML, input data, wherein the ML input data comprises: i) values of reconstructed samples; ii) values of predicted samples; iii) quantization parameters, QP. The apparatus is configured to provide the ML input data to a ML model, thereby generating ML output data; and based at least on the ML output data, generate the encoded video or the decoded video. The ML input data does not include block boundary strength, BBS, information indicating strength of a filtering applied to a boundary of samples.

In a different aspect, there is provided an apparatus for generating an encoded video or a decoded video. The apparatus is configured to obtain values of reconstructed samples; obtain quantization parameters, QPs; provide the reconstructed sample values and the quantization parameters to a machine learning, ML, model, thereby generating ML output data; based at least on the ML output data, generate first output sample values; and providing the first output sample values to a group of two or more attention residual blocks connected in series. The group of attention residual blocks comprises a first attention residual block disposed at one end of the series of attention residual blocks, and the first attention residual block is configured to receive first input data consisting of the first output sample values, and generate second output sample values based on the first output sample values.

In a different aspect, there is provided an apparatus for generating an encoded video or a decoded video. The apparatus is configured to obtain machine learning, ML, input data. The ML input data comprises: i) values of luma components of reconstructed samples; ii) values of chroma components of reconstructed samples; iii) values of luma components of predicted samples; iv) values of chroma components of predicted samples; v) first block boundary strength, BBS, information indicating strength of a filtering applied to a boundary of luma components of samples; vi) second BBS information indicating strength of a filtering applied to a boundary of chroma components of samples; and iv) quantization parameters, QP. The apparatus is configured to provide the ML input data to a ML model, thereby generating ML output data; and based at least on the ML output data, generate the encoded video or the decoded video.

In a different aspect, there is provided an apparatus for generating an encoded video or a decoded video. The apparatus is configured to obtain values of reconstructed samples; obtain quantization parameters, QPs; provide the reconstructed sample values and the quantization parameters to a machine learning, ML, model, thereby generating ML output data; based at least on the ML output data, generate first output sample values; provide the first output sample values to a group of two or more attention residual blocks connected in series, thereby generating second output sample values; and generate the encoded video or the decoded video based on the second output sample values. The group of attention residual blocks comprises a first attention residual block disposed at one end of the series of attention residual blocks, and the first attention residual block is configured to receive input data consisting of the first output sample values and the QPs.

In a different aspect, there is provided a method of generating encoded video data or decoded video data. The method comprises obtaining first input information, wherein the first input information comprises any one or more of the following parameters: i) values of reconstructed samples; ii) values of predicted samples; iii) partition information indicating how samples are partitioned; iv) block boundary strength, BS, information indicating strength of filtering applied to samples at a boundary; v) one or more quantization parameters, QPs; vi) values of deblocked samples or vii) information about prediction indicating a prediction mode. The method further comprises providing the first input information to a first processing model, thereby generating first output data. The method further comprises obtaining second input information, wherein the second input information comprises any one or more of the following parameters: i) the values of reconstructed samples; ii) the values of predicted samples; iii) the partition information; iv) the BS information; v) said one or more QPs; or vi) the values of deblocked samples. The method further comprises providing the second input information to a neural network, thereby generating one or more weight values. The method further comprises generating the encoded video data or the decoded video data based on the first output data and said one or more weight values.

In a different aspect, there is provided a method of generating encoded video data or decoded video data. The method comprises providing input data to a first convolution layer, CL, thereby generating first convoluted data; generating residual data based on the first convoluted data; and generating the encoded video data or the decoded video data based on a combination of the input data and the residual data.

In a different aspect, there is provided a computer program comprising instructions which when executed by processing circuitry cause the processing circuitry to perform the method of any one of the embodiments above.

In a different aspect, there is provided an apparatus for generating encoded video data or decoded video data. The apparatus is configured to: obtain first input information, wherein the first input information comprises any one or more of the following parameters: i) values of reconstructed samples; ii) values of predicted samples; iii) partition information indicating how samples are partitioned; iv) block boundary strength, BS, information indicating strength of filtering applied to samples at a boundary; v) one or more quantization parameters, QPs; vi) values of deblocked samples or vii) information about prediction indicating a prediction mode. The apparatus is further configured to provide the first input information to a first processing model, thereby generating first output data. The apparatus is further configured to obtain second input information, wherein the second input information comprises any one or more of the following parameters: i) the values of reconstructed samples; ii) the values of predicted samples; iii) the partition information; iv) the BS information; v) said one or more QPs; or vi) the values of deblocked samples. The apparatus is further configured to provide the second input information to a neural network, thereby generating one or more weight values. The apparatus is further configured to generate the encoded video data or the decoded video data based on the first output data and said one or more weight values.

In a different aspect, there is provided an apparatus for generating encoded video data or decoded video data. The apparatus is configured to provide input data to a first convolution layer, CL, thereby generating first convoluted data; generate residual data based on the first convoluted data; and generate the encoded video data or the decoded video data based on a combination of the input data and the residual data.

In a different aspect, there is provided an apparatus. The apparatus comprises a processing circuitry; and a memory, said memory containing instructions executable by said processing circuitry, whereby the apparatus is operative to perform the method of any one of embodiments described above.

Embodiments of this disclosure provide a way to reduce the complexity of the NN model while substantially maintaining or improving the performance of the NN model.

### BRIEF DESCRIPTION OF THE DRAWINGS

The accompanying drawings, which are incorporated herein and form part of the specification, illustrate various embodiments.

FIG. 1A shows a system according to some embodiments.

FIG. 1B shows a system according to some embodiments.

FIG. 1C shows a system according to some embodiments.

FIG. 2 shows a schematic block diagram of an encoder according to some embodiments.

FIG. 3 shows a schematic block diagram of a decoder according to some embodiments.

FIG. 4 shows a schematic block diagram of a portion of an NN filter according to some embodiments.

FIG. 5 shows a schematic block diagram of a portion of an NN filter according to some embodiments.

FIG. 6A shows a schematic block diagram of an attention block according to some embodiments.

FIG. 6B shows an example of an attention block according to some embodiments.

FIG. 6C shows a schematic block diagram of a residual block according to some embodiments.

FIG. 6D shows a schematic block diagram of an attention block according to some embodiments.

FIG. 7 shows a process according to some embodiments.

FIG. 8 shows a process according to some embodiments.

FIG. 9 shows a process according to some embodiments.

FIG. 10 shows a process according to some embodiments.

FIG. 11 shows a process according to some embodiments.

FIG. 12 shows an apparatus according to some embodiments.

FIG. 13 shows a process according to some embodiments.

FIG. 14 shows a schematic block diagram of an attentional residual (AR) block, according to some embodiments.

FIG. 15A shows a schematic block diagram of an attentional residual (AR) block, according to some embodiments.

FIG. 15B shows a schematic block diagram of an attentional residual (AR) block, according to some embodiments.

FIG. 16A shows a schematic block diagram of an attentional residual (AR) block, according to some embodiments.

FIG. 16B shows a schematic block diagram of an attentional residual (AR) block, according to some embodiments.

FIG. 17A shows a schematic block diagram of an attentional residual (AR) block, according to some embodiments.

FIG. 17B shows a schematic block diagram of an attentional residual (AR) block, according to some embodiments.

FIG. 18 shows a process according to some embodiments.

FIG. 19 shows a process according to some embodiments.

### DETAILED DESCRIPTION

The following terminologies are used in the description of the embodiments below:

Neural network: a generic term for an entity with one or more layers of simple processing units called neurons or nodes having activation functions and interacting with each other via weighted connections and biases, which collectively create a tool in the context of non-linear transforms.

Neural network architecture, network architecture, or architecture in short: the layout of a neural network describing the placement of the nodes and their connections, usually in the form of several interconnected layers, and may also specify the dimensionality of the input(s) and output(s) as well as the activation functions for the nodes.

Neural network weights, or weights in short: The weight values assigned to the connections between the nodes in a neural network.

Neural network model, or model in short: a transform in the form of a trained neural network. A neural network model may be specified as the neural network architecture, activation functions, biases, and weights.

Filter: A transform. A neural network model is one realization of a filter. The term NN filter may be used as a short form of neural-network-based filter or neural network filter.

Neural network training, or training in short: The process of finding the values for the weights and biases for a neural network. Usually, a training data set is used to train the neural network and the goal of the training is to minimize a defined error. The amount of training data needs to be sufficiently large to avoid overtraining. Training a neural network is normally a time-consuming task and typically comprises a number of iterations over the training data, where each iteration is referred to as an epoch.

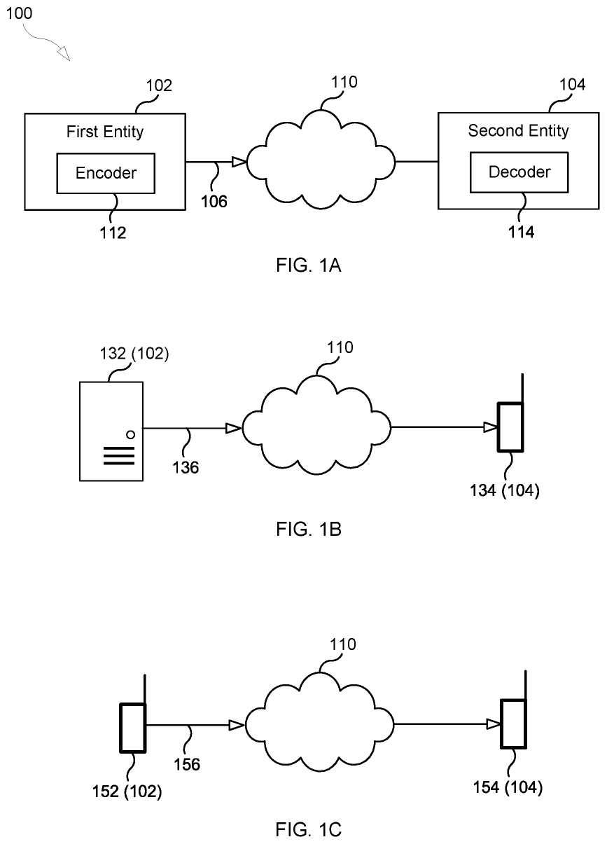

FIG. 1A shows a system 100 according to some embodiments. The system 100 comprises a first entity 102, a second entity 104, and a network 110. The first entity 102 is configured to transmit towards the second entity 104 a video stream (a.k.a., “a video bitstream,” “a bitstream,” “an encoded video”) 106.

The first entity 102 may be any computing device (e.g., a network node such as a server) capable of encoding a video using an encoder 112 and transmitting the encoded video towards the second entity 104 via the network 110. The second entity 104 may be any computing device (e.g., a network node) capable of receiving the encoded video and decoding the encoded video using a decoder 114. Each of the first entity 102 and the second entity 104 may be a single physical entity or a combination of multiple physical entities. The multiple physical entities may be located in the same location or may be distributed in a cloud.

In some embodiments, as shown in FIG. 1B, the first entity 102 is a video streaming server 132 and the second entity 104 is a user equipment (UE) 134. The UE 134 may be any of a desktop, a laptop, a tablet, a mobile phone, or any other computing device. The video streaming server 132 is capable of transmitting a video bitstream 136 (e.g., YouTube™ video streaming) towards the video streaming client 134. Upon receiving the video bitstream 136, the UE 134 may decode the received video bitstream 136, thereby generating and displaying a video for the video streaming.

In other embodiments, as shown in FIG. 1C, the first entity 102 and the second entity 104 are first and second UEs 152 and 154. For example, the first UE 152 may be an offeror of a video conferencing session or a caller of a video chat, and the second UE 154 may be an answerer of the video conference session or the answerer of the video chat. In the embodiments shown in FIG. 1C, the first UE 152 is capable of transmitting a video bitstream 156 for a video conference (e.g., Zoom™, Skype™, MS Teams™, etc.) or a video chat (e.g., Facetime™) towards the second UE 154. Upon receiving the video bitstream 156, the UE 154 may decode the received video bitstream 156, thereby generating and displaying a video for the video conferencing session or the video chat.

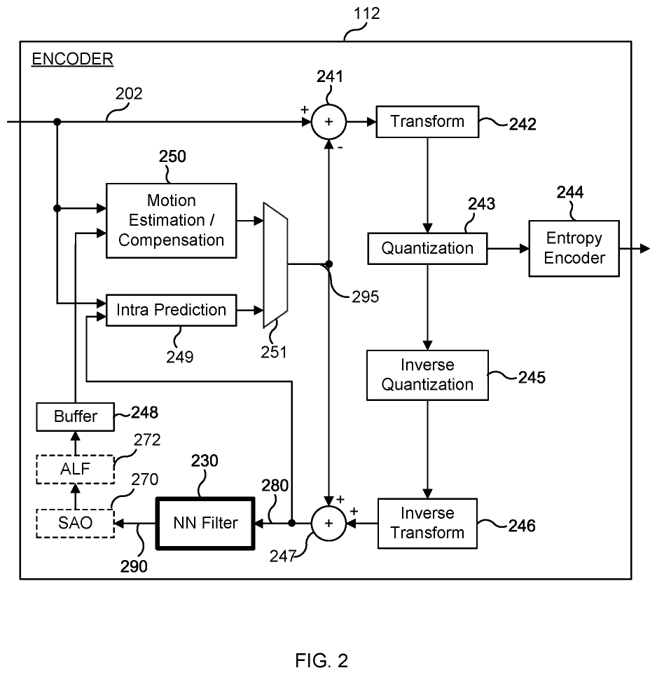

FIG. 2 shows a schematic block diagram of the encoder 112 according to some embodiments. The encoder 112 is configured to encode a block of sample values (hereafter “block”) in a video frame of a source video 202. In the encoder 112, a current block (e.g., a block included in a video frame of the source video 202) is predicted by performing a motion estimation by a motion estimator 250 from an already provided block in the same frame or in a previous frame. The result of the motion estimation is a motion or displacement vector associated with the reference block, in the case of inter prediction. The motion vector is utilized by the motion compensator 250 for outputting an inter prediction of the block.

An intra predictor 249 computes an intra prediction of the current block. The outputs from the motion estimator/compensator 250 and the intra predictor 249 are inputted to a selector 251 that either selects intra prediction or inter prediction for the current block. The output from the selector 251 is input to an error calculator in the form of an adder 241 that also receives the sample values of the current block. The adder 241 calculates and outputs a residual error as the difference in sample values between the block and its prediction. The error is transformed in a transformer 242, such as by a discrete cosine transform, and quantized by a quantizer 243 followed by coding in an encoder 244, such as by entropy encoder. In inter coding, the estimated motion vector is brought to the encoder 244 for generating the coded representation of the current block.

The transformed and quantized residual error for the current block is also provided to an inverse quantizer 245 and inverse transformer 246 to retrieve the original residual error. This error is added by an adder 247 to the block prediction output from the motion compensator 250 or the intra predictor 249 to create a reconstructed sample block 280 that can be used in the prediction and coding of a next block. The reconstructed sample block 280 is processed by a NN filter 230 according to the embodiments in order to perform filtering to combat any blocking artifact. The output from the NN filter 230, i.e., the output data 290, is then temporarily stored in a frame buffer 248, where it is available to the intra predictor 249 and the motion estimator/compensator 250.

In some embodiments, the encoder 112 may include SAO unit 270 and/or ALF 272. The SAO unit 270 and the ALF 272 may be configured to receive the output data 290 from the NN filter 230, perform additional filtering on the output data 290, and provide the filtered output data to the buffer 248.

Even though, in the embodiments shown in FIG. 2, the NN filter 230 is disposed between the SAO unit 270 and the adder 247, in other embodiments, the NN filter 230 may replace the SAO unit 270 and/or the ALF 272. Alternatively, in other embodiments, the NN filter 230 may be disposed between the buffer 248 and the motion compensator 250. Furthermore, in some embodiments, a deblocking filter (not shown) may be disposed between the NN filter 230 and the adder 247 such that the reconstructed sample block 280 goes through the deblocking process and then is provided to the NN filter 230.

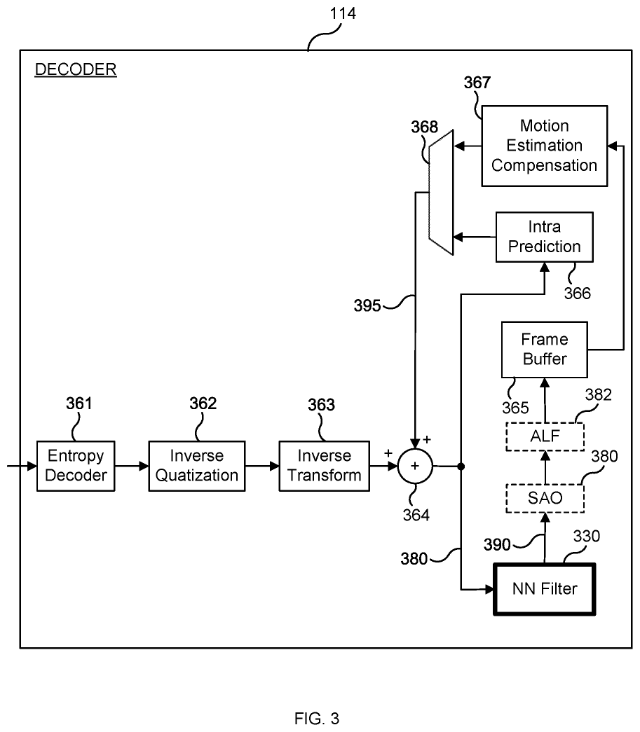

FIG. 3 is a schematic block diagram of the decoder 114 according to some embodiments. The decoder 114 comprises a decoder 361, such as entropy decoder, for decoding an encoded representation of a block to get a set of quantized and transformed residual errors. These residual errors are dequantized in an inverse quantizer 362 and inverse transformed by an inverse transformer 363 to get a set of residual errors. These residual errors are added in an adder 364 to the sample values of a reference block. The reference block is determined by a motion estimator/compensator 367 or intra predictor 366, depending on whether inter or intra prediction is performed.

A selector 368 is thereby interconnected to the adder 364 and the motion estimator/compensator 367 and the intra predictor 366. The resulting decoded block 380 output form the adder 364 is input to a NN filter unit 330 according to the embodiments in order to filter any blocking artifacts. The filtered block 390 is output form the NN filter 330 and is furthermore preferably temporarily provided to a frame buffer 365 and can be used as a reference block for a subsequent block to be decoded.

The frame buffer (e.g., decoded picture buffer (DPB)) 365 is thereby connected to the motion estimator/compensator 367 to make the stored blocks of samples available to the motion estimator/compensator 367. The output from the adder 364 is preferably also input to the intra predictor 366 to be used as an unfiltered reference block.

In some embodiments, the decoder 114 may include SAO unit 380 and/or ALF 372. The SAO unit 380 and the ALF 382 may be configured to receive the output data 390 from the NN filter 330, perform additional filtering on the output data 390, and provide the filtered output data to the buffer 365.

Even though, in the embodiments shown in FIG. 3, the NN filter 330 is disposed between the SAO unit 380 and the adder 364, in other embodiments, the NN filter 330 may replace the SAO unit 380 and/or the ALF 382. Alternatively, in other embodiments, the NN filter 330 may be disposed between the buffer 365 and the motion compensator 367. Furthermore, in some embodiments, a deblocking filter (not shown) may be disposed between the NN filter 330 and the adder 364 such that the reconstructed sample block 380 goes through the deblocking process and then is provided to the NN filter 330.

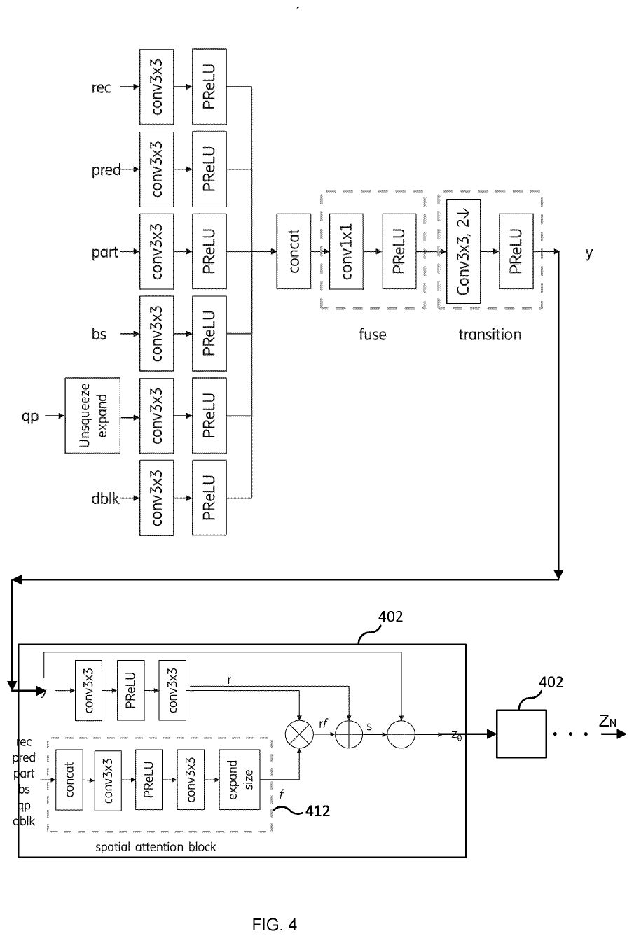

FIG. 4 is a schematic block diagram of a portion the NN filter 230/330 for filtering intra luma samples according to some embodiments. In this disclosure, luma (or chroma) intra samples are luma (or chroma) components of samples that are intra-predicted. Similarly, luma (or chroma) inter samples are luma (or chroma) components of samples that are inter-predicted.

As shown in FIG. 4, the NN filter 230/330 may have six inputs: (1) values of luma components of reconstructed samples (“rec”) 280/380; (2) values of luma components of predicted samples (“pred”) 295/395; (3) partition information indicating how luma components of samples are partitioned (“part”) (more specifically indicating how a luma picture is partitioned into coding tree units, CTUs, and how luma CTUs are partitioned into coding units,); (4) block boundary strength, BBS, information indicating strength of a filtering applied to a boundary of luma components of samples (“bs”); (5) quantization parameters (“qp”); and (6) additional input information. In some embodiments, the additional input information comprises values of luma components of deblocked samples.

Each of the six inputs may go through a convolution layer (labelled as “conv3×3” in FIG. 4) and a parametric rectified linear unit (PRELU) layer (labelled as “PRELU”) separately. The six outputs from the six PRELU layers may then be concatenated via a concatenating unit (labelled as “concat” in FIG. 4) and fused together to generate data (a.k.a., “signal”) “y.” The convolution layer “conv3×3” is a convolutional layer with kernel size 3×3 and the convolution layer “conv1×1” is a convolutional layer with kernel size 1×1. The PReLUs may make up the activation layer.

In some embodiments, qp may be a scalar value. In such embodiments, the NN filter 230/330 may also include a dimension manipulation unit (labelled as “Unsqueeze expand” in FIG. 4) that may be configured to expand qp such that the expanded qp has the same size as other inputs (i.e., rec, pred, part, bs, and dblk). However, in other embodiments, qp may be a matrix of which the size may be same as the size of other inputs (e.g., rec, pred, part, and/or bs). For example, different samples inside a CTU may be associated with a different qp value. In such embodiments, the dimension manipulation unit is not needed.

In some embodiments, the NN filter 230/330 may also include a downsampler (labelled as “2↓” in FIG. 4) which is configured to perform a downsampling with a factor of 2.

As shown in FIG. 4, the data “y” may be provided to a group of N sequential attention residual (herein after, “AR”) blocks 402. In some embodiments, the N sequential AR blocks 402 may have the same structure while, in other embodiments, they may have different structures. N may be any integer that is greater than or equal to 2. For example, N may be equal to 8.

As shown in FIG. 4, the first AR block 402 included in the group may be configured to receive the data “y” and generate first output data “z₀.” The second AR block 402 which is disposed right after the first AR block 402 may be configured to receive the first output data “z₀” and generate second output data “z₁.”

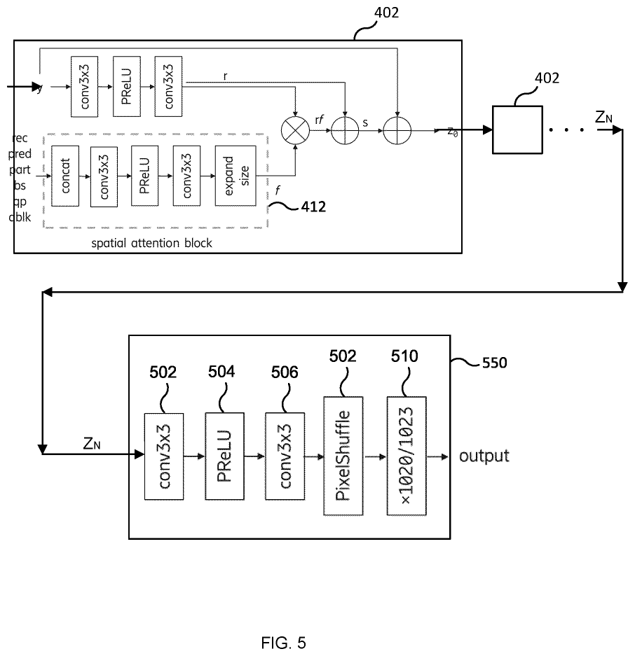

In case the group includes only two AR blocks 402 (i.e., the aforementioned first and second AR blocks), the second output data “z₁” may be provided to a final processing unit 550 (shown in FIG. 5) of the NN filter 230/330.

On the other hand, in case the group includes more than two AR blocks, each AR block 402 included in the group except for the first and the last AR blocks may be configured to receive the output data from the previous AR block 402 and provide its output data to the next AR block. The last AR block 402 may be configured to receive the output data from the previous AR block and provide its output data to the final processing unit 550 of the NN filter 230/330.

Referring back to FIG. 4, some or all of the AR blocks 402 may include a spatial attention block 412 which is configured to generate attention mask f. The attention mask f may have one channel and its size may be the same as the data “y.” Taking the first AR block 402 as an example, the spatial attention block 412 included in the first AR block 402 may be configured to multiply the attention mask f with the residual data “r” to obtain data “rf.” The data “rf” may be combined with the residual data “r” and then combined with the data “y”, thereby generating first output data “z₀.” In this disclosure, “residual data” may mean any data that is generated by processing input data (e.g., y or z) and that is to be combined with the input data.

As shown in FIG. 5, the output ZN of the group of the AR blocks 402 may be processed by a convolution layer 502, a PRELU 504, another convolution layer 506, pixel shuffling (or really sample shuffling) 508, and a final scaling 510, thereby generating the filtered output data 290/390.

Compared to the luma intra network architecture used in JVET-X0066, the NN filter 230/330 shown in FIGS. 4 and 5 improves the gain to −7/63% while maintaining the complexity of the NN filter at 430 kMAC/sample (e.g., by removing the “part” from the input while adding the “dblk” to the input).

In some embodiments, the NN filter 230/330 shown in FIGS. 4 and 5 may be used for filtering inter luma samples, intra chroma samples, and/or inter chroma samples according to some embodiments.

In case the NN filter 230/330 shown in FIGS. 4 and 5 is used for filtering inter luma samples, the partition information (“part”) may be excluded from the inputs of the NN filter 230/330 and from the inputs of the spatial attention block 412.

In case the NN filter 230/330 shown in FIGS. 4 and 5 is used for filtering intra chroma samples, the NN filter 230/330 may have the following seven inputs (instead of the six inputs shown in FIG. 4): (1) values of luma components of reconstructed samples (“rec”) 280/380; (2) values of chroma components of reconstructed samples (“recUV”) 280/380; (3) values of chroma components (e.g., Cb and Cr) of predicted samples (“predUV”) 295/395; (4) partition information indicating how chroma components of samples are partitioned (“partUV”) (more specifically indicating how a luma picture is partitioned into coding tree units, CTUs, and how luma CTUs are partitioned into coding units); (5) block boundary strength, BBS, information indicating strength of a filtering applied to a boundary of chroma components of samples (“bsUV”); (6) quantization parameters (“qp”); and (7) additional input information. In some embodiments, the additional input information comprises values of chroma components of deblocked samples. Similarly, the above seven inputs may be used as the inputs of the spatial attention block 412.

In case the NN filter 230/330 shown in FIGS. 4 and 5 is used for filtering inter chroma samples, the partition information (“partUV”) may be excluded from the above seven inputs of the NN filter 230/330 and from the seven inputs of the spatial attention block 412.

As discussed above, in some embodiments, the additional input information comprises values of luma or chroma components of deblocked samples. However, in other embodiments, the additional input information may comprise information about predicted samples (a.k.a., “prediction mode information” or “I/P/B prediction mode information”).

For example, the prediction mode information may indicate whether a sample block that is subject to the filtering is an intra-predicted block, an inter-predicted block that is uni-predicted, or an inter-predicted block that is bi-predicted. More specifically, the prediction mode information may be set to have a value 0 if the sample belongs to an intra-predicted block, a value of 0.5 if the sample belongs to an inter-predicted block that is uni-predicted, or a value of 1 if the sample belongs to an inter-predicted block that is bi-predicted.

Since I-frames only contain I-blocks, the prediction mode information may be constant (e.g., 0) if this architecture is used for luma intra network. On the other hand if this architecture is used for luma inter network, the prediction mode information may be set to different values for different samples and can provide Bjontegaard-delta rate (BDR) gain over the architecture which does not utilize this prediction mode information.

Instead of using the values of luma or chroma components of deblocked samples or the prediction mode information as the additional input information, in some embodiments, motion vector (MV) information may be used as the additional input information. The MV information may indicate the number of MVs (e.g., 0, 1, or 2) used in the prediction. For example, 0 MV may mean that the current block is an I block, 1 MV may mean a P block, 2 MVs may mean a B block.

In some embodiments, in addition to the prediction mode information or the MV information, prediction direction information indicating a direction of prediction for the samples that are subject to the filtering may be included in the additional input information.

Instead of using i) the values of luma or chroma components of deblocked samples, ii) the prediction mode information, or iii) the MV information as the additional input information, in some embodiments, coefficient information may be used as the additional input information.

One example of the coefficient information is skipped block information indicating whether a block of samples that are subject to the NN filtering is a block that is skipped (i.e., the block that did not go through the processes performed by transform unit 242, quantization unit 243, inverse quantization unit 245, and inverse transform unit 246 or the processes performed by the entropy decoder 361, inverse quantization unit 362, and inverse transform unit 363). In one example, the skipped block information may be set to have a value of 0 if the block of samples subject to the NN filtering is a block that is not skipped and 1 if the block is a skipped block.

With respect to the encoder 112 shown in FIG. 2, a skipped block may correspond to reconstructed samples 280 that are obtained based solely on the predicted samples 295 (instead of a sum of the predicted samples 295 and the output from the inverse transform unit 246). Similarly, with respect to the decoder 114 shown in FIG. 3, a skipped block may correspond to the reconstructed samples 380 that are obtained based solely on the predicted samples 395 (instead of a sum of the predicted samples 395 and the output from the inverse transform unit 363).

Since I-frames only contain I-blocks, and these blocks cannot be skipped, the skipped block information would be constant (e.g., 0) if this architecture is used for luma intra network. On the other hand, if this architecture is used for luma inter network, the skipped block information may have different values for different samples, and can provide a BDR gain over other alternative architectures which do not utilize the skipped block information.

Referring back to FIG. 4, as shown in FIG. 4, in some embodiments, the NN filter 230/330 for filtering intra luma samples have six inputs. However, in other embodiments, the partition information may be removed from the inputs, making the total number of inputs of the NN filter 230/330 five: i.e., (1) values of luma components of reconstructed samples (“rec”) 280/380; (2) values of luma components of predicted samples (“pred”) 295/395; (3) block boundary strength, BBS, information indicating strength of a filtering applied to a boundary of luma components of samples (“bs”); (4) quantization parameters (“qp”); and (5) additional input information. In some embodiments, the additional input information comprises values of luma components of deblocked samples. As discussed above, in case the NN filter 230/330 shown in FIG. 4 is used for filtering inter luma samples, the inputs of the NN filter 230/330 have the five inputs (excluding the partition information) instead of the six inputs. Similarly, the inputs of the spatial attention block 412 would be the five inputs instead of the six inputs. Thus, in these embodiments, the inputs of the NN filter 230/330 used for filtering intra luma samples and the inputs of the NN filter 230/330 used for filter inter luma samples would be the same.

Instead of removing the partition information from the inputs, in some embodiments, the BBS information may be removed from the inputs. Thus, in these embodiments, the inputs of the NN filter 230/330 for filtering intra luma samples are: (1) values of luma components of reconstructed samples (“rec”) 280/380; (2) values of luma components of predicted samples (“pred”) 295/395; (3) partition information indicating how luma components of samples are partitioned (“part”); (4) quantization parameters (“qp”); and (5) additional input information. In case the NN filter 230/330 is used for filtering inter luma samples, inter chroma samples, or intra chroma samples, the BBS information may be removed from the inputs of the NN filter 230/330 and the inputs of the special attention block 412.

As discussed above, in some embodiments, different inputs are provided to the NN filter 230/330 for its filtering operation. For example, in some embodiments, “rec,” “pred,” “part,” “bs,” “qp,” and “dblk” are provided as the inputs of the NN filter 230/330 for luma components of intra-predicted samples while “rec,” “pred,” “bs,” “qp,” and “dblk” are provided as the inputs of the NN filter 230/330 for luma components of inter-predicted samples. Similarly, in some embodiments, “rec,” “recUV,” “predUV,” “partUV,” “bsUV,” “qp,” and “dblk” are provided as the inputs of the NN filter 230/330 for chroma components of intra-predicted samples while “rec,” “recUV,” “predUV,” “bsUV,” “qp,” and “dblk” are provided as the inputs of the NN filter 230/330 for luma components of inter-predicted samples. In other words, four different NN filters 230/330 may be used for four different types of samples-inter luma samples, intra luma samples, inter chroma samples, and intra chroma samples.

However, in other embodiments, the same NN filter 230/330 may be used for luma components of samples (regardless of whether they are inter-predicted or intra-predicted) and the same NN filter 230/330 may be used for chroma components of samples (regardless of whether they are inter-predicted or intra-predicted). In such embodiments, instead of using two different filters, “IPB-info” may be used to differentiate inter blocks and intra blocks from each other. Thus, in one example, “rec,” “pred,” “part,” “bs,” “qp,” and “IPB-info” are provided as the inputs of the NN filter 230/330 for luma components of samples (whether they are inter-predicted or intra-predicted) while “rec,” “recUV,” “predUV,” “partUV,” “bsUV,” “qp,” and “IPB-info” are provided as the inputs of the NN filter 230/330 for chroma components of samples (whether they are inter-predicted or intra-predicted).

Alternatively, in some embodiments, the same NN filter 230/330 may be used for any component of samples that are intra-predicted and the same NN filter 230/330 may be used for any component of samples that are inter-predicted. In these embodiments, the same inputs are used for luma components of samples and chroma components of samples. Thus, in one example, “rec,” “pred,” “part,” “bs,” “recUV,” “predUV,” “partUV,” “bsUV,” “qp,” are provided as the inputs of the NN filter 230/330 for intra-predicted samples while “rec,” “pred,” “bs,” “recUV,” “predUV,” “bsUV,” “qp” are provided as the inputs of the NN filter 230/330 for inter-predicted samples. In these embodiments, the outputs of the NN filters 230/330 are NN-filtered luma samples and NN-filtered chroma samples.

Instead of using two different NN filters 230/330, in some embodiments, the same NN filter 230/330 may be used for the four different types of samples-inter luma samples, intra luma samples, inter chroma samples, and intra chroma samples. In these embodiments, the inter or intra information may be given by “IPB-info” and the cross component benefits may be given by taking in both luma and chroma related inputs. Thus, in one example, “rec,” “pred,” “part,” “bs,” “recUV,” “predUV,” “partUV,” “bsUV,” “qp,” and “IPB-info” are provided as the inputs of the NN filter 230/330 for the four different types of samples.

In the above discussed embodiments, the performance and/or efficiency of the NN filter 230/330 is improved by adjusting the inputs provided to the NN filter 230/330. However, in some embodiments, the performance and/or efficiency of the NN filter 230/330 is improved by changing the structure of the AR block 402.

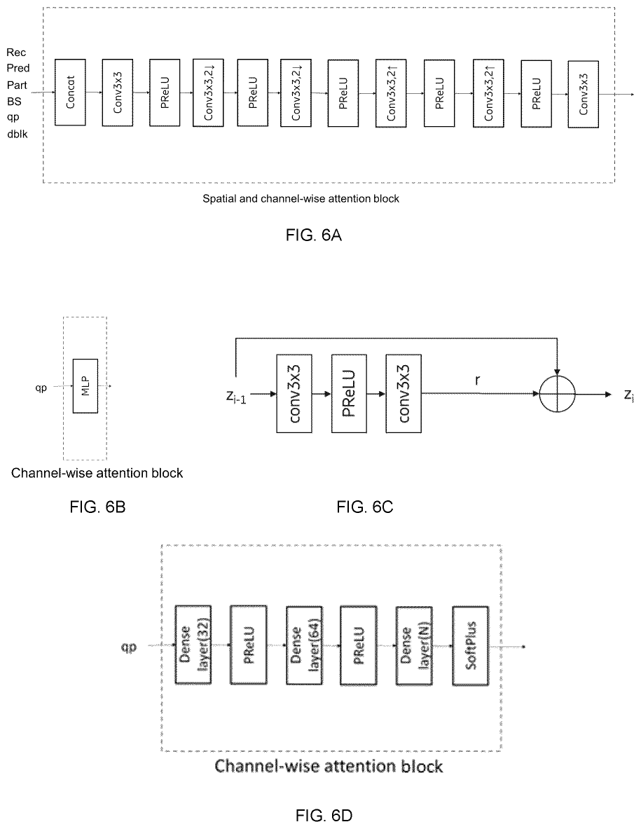

More specifically, in some embodiments, the spatial attention block 412 may be removed from first M AR blocks 402, as shown in FIG. 6C (compare with the spatial attention block 412 shown in FIG. 4). For example, in case 8 (or 16) AR blocks 402 are included in the NN filter 230/330, the first 7 (or 15) AR blocks 402 may not include the spatial attention block 412 and only the last AR block 402 may include the spatial attention block 412. In another example, none of the AR blocks 402 included in the NN filter 230/330 includes the spatial attention block 412.

In case the AR block 402 having the structure shown in FIG. 6C is the first AR block included in the NN filter 230/330, input data y may be provided to a first convolution layer (the left “conv3×3” in FIG. 6C), thereby generating first convoluted data. On the other hand, in case the AR block 402 having the structure shown in FIG. 6C is not the first AR block included in the NN filter 230/330, input data zᵢ₋₁ may be provided to a first convolution layer (the left “conv3×3” in FIG. 6C), thereby generating first convoluted data. Here zᵢ₋₁ is the output of the previous AR block.

As shown in FIG. 6C, the first convoluted data may be provided to a parametric rectified linear unit (PReLU), thereby generating rectified data, and the rectified data may be provided to a second convolution layer (the right “conv3×3” in FIG. 6C), thereby generating second convoluted data. Here, the second convoluted data is the residual data r. Based on a combination of the residual data r and the input data (y or zᵢ₋₁), the output of the AR block 402 may be generated. For example, the output of the AR block 402 may be equal to y+r or zᵢ₋₁+r.

In some embodiments, instead of or in addition to adjusting the inputs of the NN filter 230/330 and/or removing the spatial attention block 412 from the AR block 402, the performance and/or efficiency of the NN filter 230/330 may be improved by adjusting the capacity of the spatial attention block 412. For example, in some embodiments, the number of layers in the spatial attention block 412 may be increased (with respect to the number of layers in the JVET-X0066) and configure the layers to perform down-sampling and up-sample in order to improve the performance of capturing the correlation of the latent. An example of the spatial attention block 412 according to these embodiments is shown in FIG. 6A.

In some embodiments, instead of or in addition to increasing the capacity of the spatial attention block 412, the output of the spatial attention block 412 may be increased from one channel to a plurality of channels in order to provide the spatial and channel-wise attention. For example, generally, in the CNN layer(s) included in the spatial attention block 412, a single kernel (e.g., having the size of 3×3) is used for performing the convolution operations. However, in these embodiments, a plurality of kernels (e.g., 96) may be used for performing the convolution operations. As a result of using multiple kernels (each of which is associated with a particular channel), multiple channel outputs may be generated.

In some embodiments, in generating produce the channel-wise attention, only the “qp” may be used. For example, as shown in FIG. 6B, a multilayer perceptron (MLP) may be used to generate multiple channel outputs using the “QP” as the input. MLP is a class of feedforward artificial neural network (ANN, usually simply called neural networks). The term MLP is used ambiguously, sometimes loosely to mean any feedforward ANN, sometimes strictly to refer to networks composed of multiple layers of perceptrons (with threshold activation). Multilayer perceptrons are sometimes colloquially referred to as ‘vanilla’ neural networks, especially when they have a single hidden layer. An MLP consists of at least three layers of nodes: an input layer, a hidden layer and an output layer. An exemplary implementation of these embodiments is shown in FIG. 6D. As shown in FIG. 6D, the spatial attention block 412 may include PRELU layers, dense layers, and SoftPlus layer(s), and these layers may be used together to generate the multiple channel outputs using the “QP” as the input. In some embodiments, the Softplus layer (a.k.a., Softplus activation function) may be defined as follows: softplus(x)=log(1+e^{x}). A dense layer is a layer that is deeply connected with its preceding layer which means the neurons of the layer are connected to every neuron of its preceding layer. In some embodiments, instead of performing the attention operation, e.g., multiplication, from the output of the MLP with the residue data “r,” the operation can be performed with the output data “zᵢ” shown in FIG. 6C.

The embodiments of this disclosure provide any least one of the following advantages.

By retraining the luma intra model from JVET-Y0143, the model gives a luma gain of-7.57% for all-intra configuration. The difference between the previous gain of 7.39% reported in JVET-X0066 and that of the retrained network of 7.57% is due to a different training procedure. As an example, the training time for the retrained network may have been longer. By removing the partition input “part”, the gain is still 7.57%, and the complexity is reduced from 430 kMAC/pixel to 419 kMAC/pixel. By removing an additional bs input “bs”, the gain is 7.42%, and the complexity is reduced to 408 kMAC/pixel.

By removing the first seven spatial attention masks, the gain is 7.60%, and the complexity is reduced from 430 kMAC/pixel to 427 kMAC/pixel.

By using the deblocked information as input and removing the partition input, the gain improves to 7.63%, while the complexity remains the same 430 kMAC/pixel.

By removing all the spatial attention masks, the gain is 7.72% for class D sequences.

By increasing the capacity of the attention branch, the gain is improved from 7.70% to 7.85% for class D sequences. The complexity is increased to around 120%.

By using channel-wise attention with qp as input, a gain of 7.78% is obtained for class D sequences, and the complexity is reduced to 428.7 kMAC/pixel.

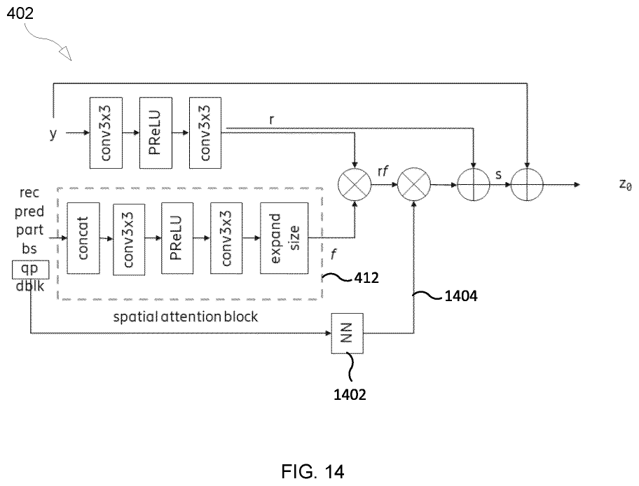

As shown in FIG. 14, in some embodiments, the spatial attention block 412 included in the AR block 402 may be a spatial channel-wise attention block (meaning that the block is capable of performing the channel-wise attention operation). However, in other embodiments, the spatial attention block 412 may just be a spatial attention block and channel-wise attention operation may be performed on the output of the spatial attention block 412.

More specifically, according to some embodiments of this disclosure, a separate neural network (NN) model (1402, 1502, 1602, or 1702) is provided. The separate NN model is configured to generate one or more weight values (1404, 1504, 1604, or 1704) based on input information comprising any one or more of the following parameters: i) value(s) of reconstructed samples; ii) value(s) of predicted samples; iii) partition information indicating how samples are partitioned; iv) block boundary strength, BS, information indicating strength of filtering applied to samples at a boundary; v) one or more quantization parameters, QPs; vi) value(s) of deblocked samples or information about prediction indicating a prediction mode (e.g., an intra-prediction, a uni-direction inter-prediction, or a bi-direction inter-prediction); vii) skip-mode information indicating if a block is a skip-block. In one example, the input information may consist of the one or more QPs. Each of the above parameters may be a single value or a matrix (i.e., a plurality of values). In another example, the mean of each matrix can be used instead of the matrix itself. More specifically, in some embodiments, instead of providing multiple values of a matrix for each channel to the NN model (e.g., comprising an MLP), a vector of multiple scalar values each of which corresponds to a mean value of the multiple values of the matrix for each channel.

The weight value(s) generated by the separate NN model may be used for performing the channel-wise attention operation on the output of the spatial attention block 412.

For example, as discussed above with respect to the embodiments shown in FIG. 4, the spatial attention block 412 included in the first AR block 402 may be configured to multiply the attention mask f with the residual data “r” to obtain data “rf.” However, instead of combining the data “rf” with the residual data “r” and the data “y,” as shown in FIG. 4 (i.e., in FIG. 4, z0=rf+r+y), in the embodiments shown in FIG. 14, the data “rf” is multiplied by the one or more weight values 1404 first, and then added with the residual data “r” and the data “y” (i.e., in FIG. 14, z0=rf×w+r+y).

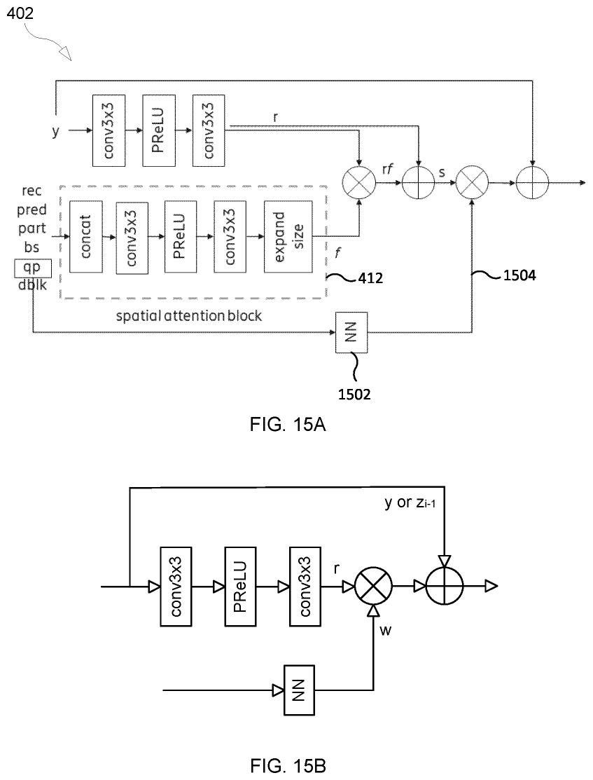

Alternatively, in the embodiments shown in FIG. 15A, the data “rf” is combined with the residual data “r” first, and then multiplied by the one or more weight values, and then added with the data “y” (i.e., in FIG. 15A, z0=(rf+r)×w+y). Alternatively, as shown in FIG. 15B, in case the AR block 402 has the structure shown in FIG. 6C (i.e., in case the AR block 402 does not have the spatial attention block 412), the output of the AR block 402 would be (r×w)+y (or zᵢ₋₁ in case the AR block 402 is not the first AR block).

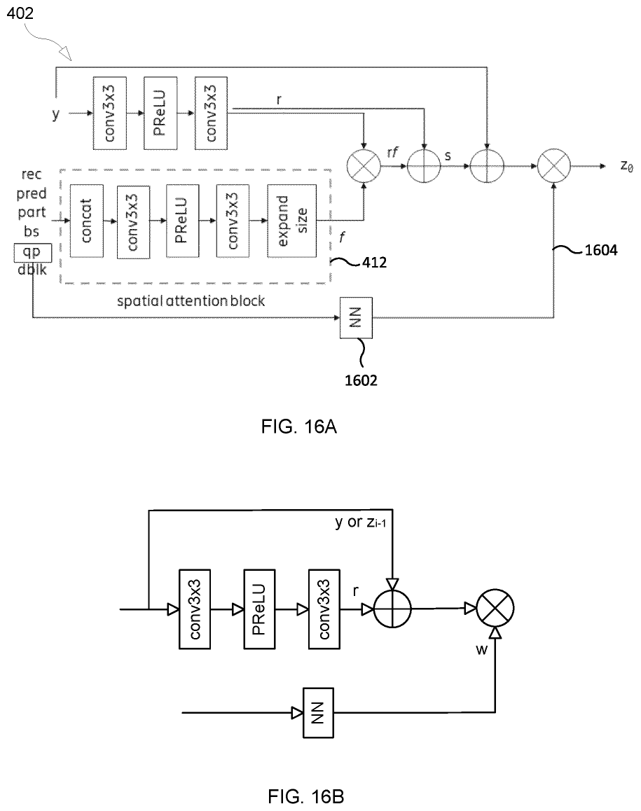

Alternatively, in the embodiments shown in FIG. 16A, the data “rf” is combined with the residual data “r” and the data “y”, and then multiplied by the one or more weight values (i.e., in FIG. 16A, z0=(rf+r+y)×w). Alternatively, as shown in FIG. 16B, in case the AR block 402 has the structure shown in FIG. 6C (i.e., in case the AR block 402 does not have the spatial attention block 412, the output of the AR block 402 would be (r+y)×w or (r+zᵢ₋₁)×w in case the AR block 402 is not the first AR block).

As discussed above, in some embodiments, the channel-wise attention may be performed by applying the one or more weight values after generating the data “rf.” However, in other embodiments, the channel-wise attention may be performed by applying the one or more weight values during the process of generating the residual data “r.”

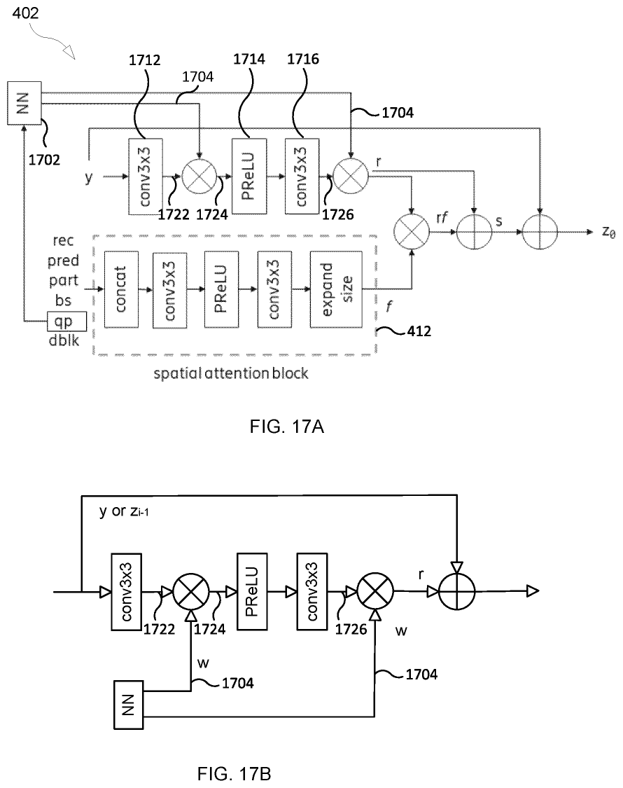

For example, as shown in FIG. 17A, during the process of generating the residual data “r” using the data “y,” the one or more weight values may be applied. More specifically, in the embodiments shown in FIG. 17A, after the data “y” is provided to CNN 1712, thereby generating first convoluted data 1722, the first convoluted data 1722 may be multiplied by the one or more weight values, thereby generating the weighted first convoluted data 1724. The weighted first convoluted data 1724 may be provided to PRELU 1714 and CNN 1716, thereby generating second convoluted data 1726. The second convoluted data 1726 may be multiplied by the one or more weight values, thereby generating the residual data r. In this case, the output of the AR block 402 is rf+r+y where r corresponds to the residual data r. As shown in FIG. 17B, in case the AR block 402 has the structure shown in FIG. 6C (i.e., in case the AR block 402 does not have the spatial attention block 412, the output of the AR block 402 would be r+y or r+zᵢ₋₁ in case the AR block 402 is not the first AR block).

In some embodiments, the NN model (1402, 1502, 1602, or 1702) may be a multiplayer perceptron (MLP) NN (like the channel-wise attention block shown in FIG. 6B). FIG. 6D shows an example of MLP NN. Alternatively, the NN model may have the same structure as the spatial attention block 412 shown in FIG. 4. The outputs may be down-sampled and reshaped to provide the channel-wise weights.

As discussed above, the spatial attention block 412 is configured to perform spatial attention operation based on input information comprising any one or more of the following parameters: i) value(s) of reconstructed samples; ii) value(s) of predicted samples; iii) partition information indicating how samples are partitioned; iv) block boundary strength, BS, information indicating strength of filtering applied to samples at a boundary; v) one or more quantization parameters, QPs; vi) value(s) of deblocked samples or information about prediction indicating a prediction mode (e.g., an intra-prediction, a uni-direction inter-prediction, or a bi-direction inter-prediction).

Like the spatial attention block 412, as discussed above, the NN model (1402, 1502, 1602, or 1702) is configured to generate one or more weight values (1404, 1504, 1604, or 1704) based on the input information comprising any one or more of the following parameters: i) value(s) of reconstructed samples; ii) value(s) of predicted samples; iii) partition information indicating how samples are partitioned; iv) block boundary strength, BS, information indicating strength of filtering applied to samples at a boundary; v) one or more quantization parameters, QPs; vi) value(s) of deblocked samples or information about prediction indicating a prediction mode (e.g., an intra-prediction, a uni-direction inter-prediction, or a bi-direction inter-prediction).

Thus, in some embodiments, the parameters included in the input information for the spatial attention block 412 and the parameters included in the input information for the NN model may at least partially overlap (in one example, they may be the same). However, in other embodiments, the parameters included in the input information for the spatial attention block 412 and the parameters included in the input information for the NN model do not overlap.

As shown in FIG. 3, in some embodiments, the NN filter 330 may comprise a plurality of AR blocks 402. In such embodiments, the spatial attention block 412 and the NN model (1402, 1502, 1602, or 1702) may be included in every AR block 402 or in only some of the AR blocks 402. For example, the spatial attention block 412 and the NN model may be included in all of the middle AR blocks 402 (i.e., the AR blocks that are not disposed at the ends). In another example, the spatial attention block 412 is included in a first group of AR blocks and the NN model is included in a second group of AR blocks, where the first and second groups do not overlap or partially overlaps.

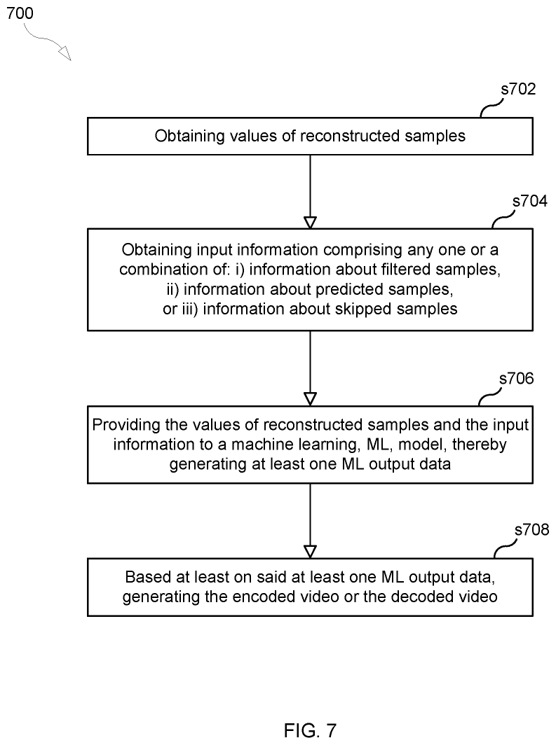

FIG. 7 shows a process 700 for generating an encoded video or a decoded video. The process 700 may begin with step s702. Step s702 comprises obtaining values of reconstructed samples. Step s704 comprises obtaining input information comprising any one or a combination of: i) information about filtered samples, ii) information about predicted samples, or iii) information about skipped samples. Step s706 comprises providing the values of reconstructed samples and the input information to a machine learning, ML, model, thereby generating at least one ML output data. Step s708 comprises, based at least on said at least one ML output data, generating the encoded video or the decoded video.

In some embodiments, the ML model comprises a first pair of models and a second pair of models, the first pair of models comprises a first convolution neural network, CNN, and a first parametric rectified linear unit, PRELU, coupled to the first CNN, the second pair of models comprises a second CNN and a second PRELU coupled to the second CNN, the values of the reconstructed samples are provided to the first CNN, and the input information is provided to the second CNN.

In some embodiments, the method further comprises: obtaining values of predicted samples; obtaining block boundary strength information, BBS, indicating strength of filtering applied to a boundary of samples; obtaining quantization parameters, QPs; providing the values of the predicted samples to the ML model, thereby generating at least first ML output data; providing the BBS information to the ML model, thereby generating at least second ML output data; providing the QPs to the ML model, thereby generating at least third ML output data; and combining said at least one ML output data, said at least ML output data, said at least second ML output data, and said at least third ML output data, thereby generating combined ML output data, and the encoded video or the decoded video is generated based at least on the combined ML output data.

In some embodiments, the information about filtered samples comprises values of deblocked samples.

In some embodiments, the information about prediction indicates a prediction mode, and the prediction mode comprises an intra-prediction, a uni-direction inter-prediction, and a bi-direction inter-prediction.

In some embodiments, the information about prediction indicates a number of motion vectors used for prediction.

In some embodiments, the information about skipped samples indicates whether samples belong to a block that did not go through a process processing residual samples, and the process comprises inverse quantization and inverse transformation.

In some embodiments, the method further comprises concatenating the values of reconstructed samples and the input information, thereby generating concatenated ML input data, wherein the concatenated ML input data are provided to the ML model.

In some embodiments, the ML model comprises a first pair of models and a second pair of models, the first pair of models comprises a first convolution neural network, CNN, and a first parametric rectified linear unit, PRELU, coupled to the first CNN, the second pair of models comprises a second CNN and a second PRELU coupled to the second CNN, the first CNN is configured to perform downsampling, and the second CNN is configured to perform upsampling.

In some embodiments, the ML model comprises a convolution neural network, CNN, the CNN is configured to convert the concatenated ML input data into N ML output data, and N is the number of kernel filters included in the CNN.

In some embodiments, the input information comprises the information about predicted samples. The method further comprises: obtaining partition information indicating how samples are partitioned; and providing the partition information to the ML model, thereby generating fourth ML output data. The combined ML output data is generated based on combining said at least one ML output data, the first ML output data, the second ML output data, the third ML output data, and the fourth ML output data.

In some embodiments, the values of the reconstructed samples include values of luma components of the reconstructed samples and values of chroma components of the reconstructed samples, the values of the predicted samples include values of luma components of the predicted samples and values of chroma components of the predicted samples, and the BBS information indicates strength of filtering applied to a boundary of luma components of samples and strength of filtering applied to a boundary of chroma components of samples.

In some embodiments, the method further comprises obtaining first partition information indicating how luma components of samples are partitioned; obtaining second partition information indicating how chroma components of samples are partitioned; providing the first partition information to the ML model, thereby generating fourth ML output data; and providing the second partition information to the ML model, thereby generating fifth ML output data, wherein the input information comprises the information about predicted samples, and the combined ML output data is generated based on combining said at least one ML output data, the first ML output data, the second ML output data, the third ML output data, the fourth ML output data, and the fifth ML output data.

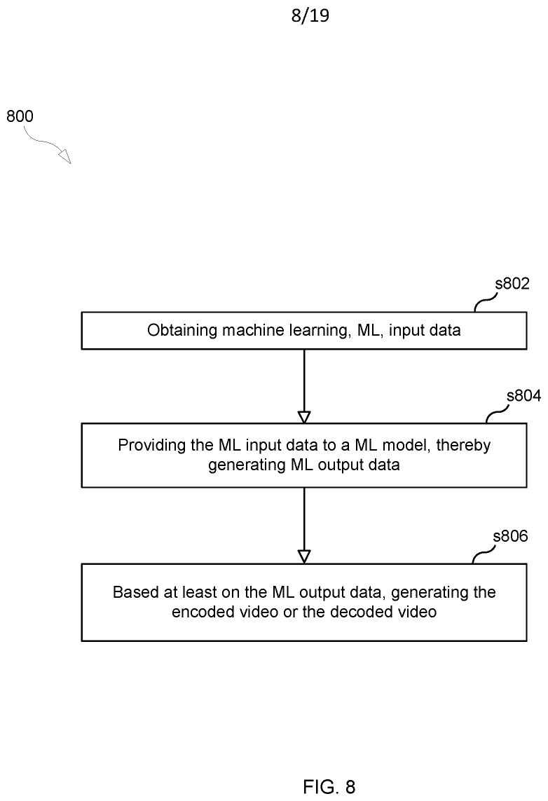

FIG. 8 shows a process 800 for generating an encoded video or a decoded video. The process 800 may begin with step s802. Step s802 comprises obtaining machine learning, ML, input data, wherein the ML input data comprises: i) values of reconstructed samples; ii) values of predicted samples; iii) block boundary strength, BBS, information indicating strength of a filtering applied to a boundary of samples; and iv) quantization parameters, QP. Step s804 comprises providing the ML input data to a ML model, thereby generating ML output data. Step s806 comprises, based at least on the ML output data, generating the encoded video or the decoded video. The ML input data does not include partition information indicating how a luma picture is partitioned into coding tree units, CTUs, and how luma CTUs are partitioned into coding units, CUs.

In some embodiments, the ML model consists of a first pair of models, a second pair of models, a third pair of models, and a fourth pair of models, the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the fourth pair of models comprises a fourth CNN and a fourth PRELU coupled to the fourth CNN, the values of the reconstructed samples are provided to the first CNN, the values of predicted samples are provided to the second CNN, the BBS information is provided to the third CNN, and the QPs are provided to the fourth CNN.

In some embodiments, the values of reconstructed samples comprise values of luma components of the reconstructed samples and chroma components of the reconstructed samples, the ML model consists of a first pair of models, a second pair of models, a third pair of models, a fourth pair of models, and a fifth pair of models, the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the fourth pair of models comprises a fourth CNN and a fourth PRELU coupled to the fourth CNN, the fifth pair of models comprises a fifth CNN and a fifth PRELU coupled to the fifth CNN, the values of the luma components of the reconstructed samples are provided to the first CNN, the values of the chroma components of the reconstructed samples are provided to the second CNN, the values of predicted samples are provided to the third CNN, the BBS information is provided to the fourth CNN, and the QPs are provided to the fifth CNN.

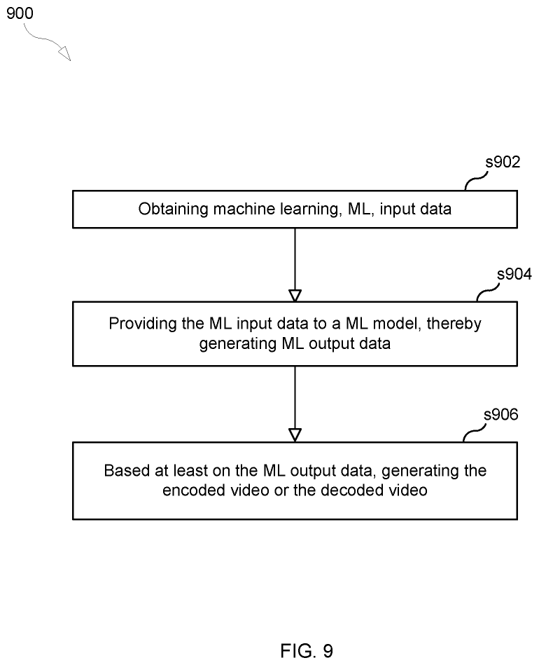

FIG. 9 shows a process 900 for generating an encoded video or a decoded video. The process 900 may begin with step s902. Step s902 comprises obtaining machine learning, ML, input data, wherein the ML input data comprises: i) values of reconstructed samples; ii) values of predicted samples; iii) quantization parameters, QP. Step s904 comprises providing the ML input data to a ML model, thereby generating ML output data. Step s906 comprises, based at least on the ML output data, generating the encoded video or the decoded video. The ML input data does not include block boundary strength, BBS, information indicating strength of a filtering applied to a boundary of samples.

In some embodiments, the ML model consists of a first pair of models, a second pair of models, and a third pair of models, the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the values of the reconstructed samples are provided to the first CNN, the values of predicted samples are provided to the second CNN, and the QPs are provided to the third CNN.

In some embodiments, the values of reconstructed samples comprise values of luma components of the reconstructed samples and chroma components of the reconstructed samples, the ML model consists of a first pair of models, a second pair of models, a third pair of models, and a fourth pair of models, the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the fourth pair of models comprises a fourth CNN and a fourth PRELU coupled to the fourth CNN, the values of the luma components of the reconstructed samples are provided to the first CNN, the values of the chroma components of the reconstructed samples are provided to the second CNN, the values of predicted samples are provided to the third CNN, and the QPs are provided to the fourth CNN.

In some embodiments, the values of reconstructed samples comprise values of luma components of the reconstructed samples and chroma components of the reconstructed samples, the ML input data further comprises partition information indicating how samples are partitioned, the ML model consists of a first pair of models, a second pair of models, a third pair of models, a fourth pair of models, and a fifth pair of models, and the first pair of models comprises a first convolution neural network, CNN, and a first parametric rectified linear unit, PRELU, coupled to the first CNN, the second pair of models comprises a second CNN and a second PRELU coupled to the second CNN, the third pair of models comprises a third CNN and a third PRELU coupled to the third CNN, the fourth pair of models comprises a fourth CNN and a fourth PRELU coupled to the fourth CNN, the values of the luma components of the reconstructed samples are provided to the first CNN, the values of the chroma components of the reconstructed samples are provided to the second CNN, the values of predicted samples are provided to the third CNN, the QPs are provided to the fourth CNN, and the partition information is provided to the fifth CNN.

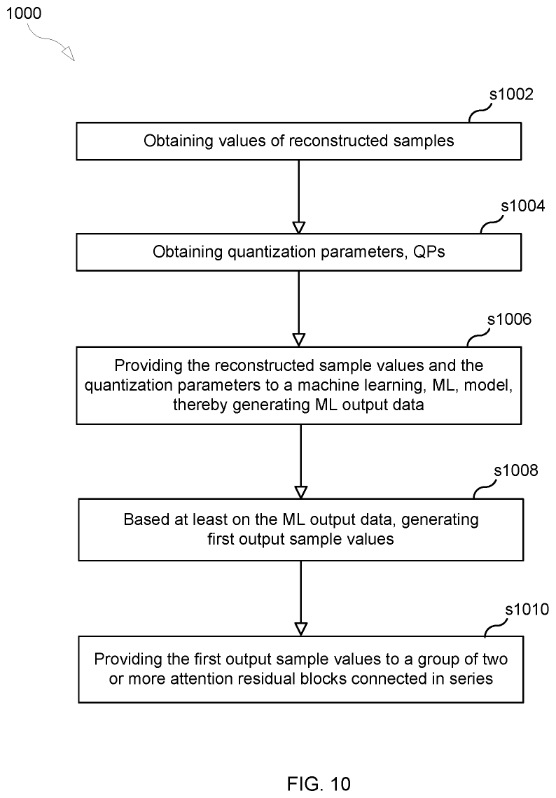

FIG. 10 shows a process 1000 for generating an encoded video or a decoded video. The process 1000 may begin with step s1002. Step s1002 comprises obtaining values of reconstructed samples. Step s1004 comprises obtaining quantization parameters, QPs. Step s1006 comprises providing the reconstructed sample values and the quantization parameters to a machine learning, ML, model, thereby generating ML output data. Step s1008 comprises, based at least on the ML output data, generating (s1008) first output sample values. Step s1010 comprises providing the first output sample values to a group of two or more attention residual blocks connected in series. The group of attention residual blocks comprises a first attention residual block disposed at one end of the series of attention residual blocks, and the first attention residual block is configured to receive first input data consisting of the first output sample values, and generate second output sample values based on the first output sample values.

In some embodiments, the group of attention residual blocks comprises a second attention residual block disposed at an opposite end of the series of attention residual blocks, the second attention residual block is configured to receive second input data comprising the values of the reconstructed samples and/or the QPs, and the second attention residual block is configured to generate third output sample values based on the values of the reconstructed samples and/or the QPs.

In some embodiments, the method further comprises obtaining values of predicted samples; obtaining block boundary strength, BBS, information indicating strength of a filtering applied to a boundary of samples; and providing the values of the predicted samples and the BBS information to a ML model, thereby generating spatial attention mask data, wherein the third output sample values are generated based on the spatial attention mask data.

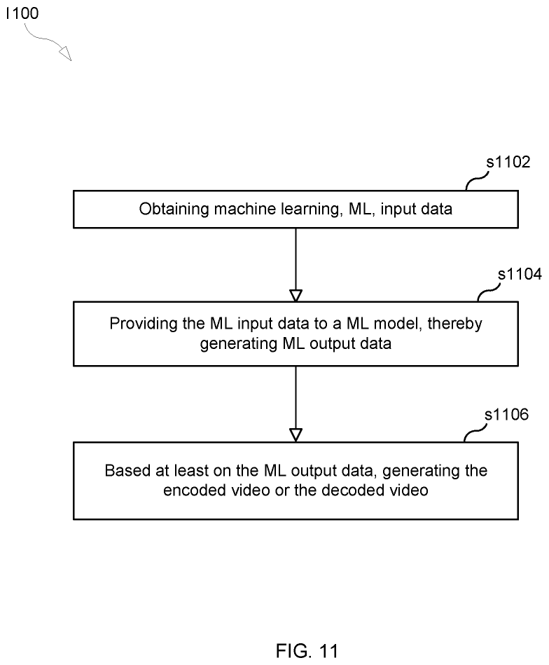

FIG. 11 shows a process 1100 for generating an encoded video or a decoded video. The process 1100 may begin with step s1102. Step s1102 comprises obtaining machine learning, ML, input data, wherein the ML input data comprises: i) values of luma components of reconstructed samples; ii) values of chroma components of reconstructed samples; iii) values of luma components of predicted samples; iv) values of chroma components of predicted samples; v) first block boundary strength, BBS, information indicating strength of a filtering applied to a boundary of luma components of samples; vi) second BBS information indicating strength of a filtering applied to a boundary of chroma components of samples; and iv) quantization parameters, QP. Step s1104 comprises providing the ML input data to a ML model, thereby generating ML output data. Step s1106 comprises based at least on the ML output data, generating the encoded video or the decoded video.

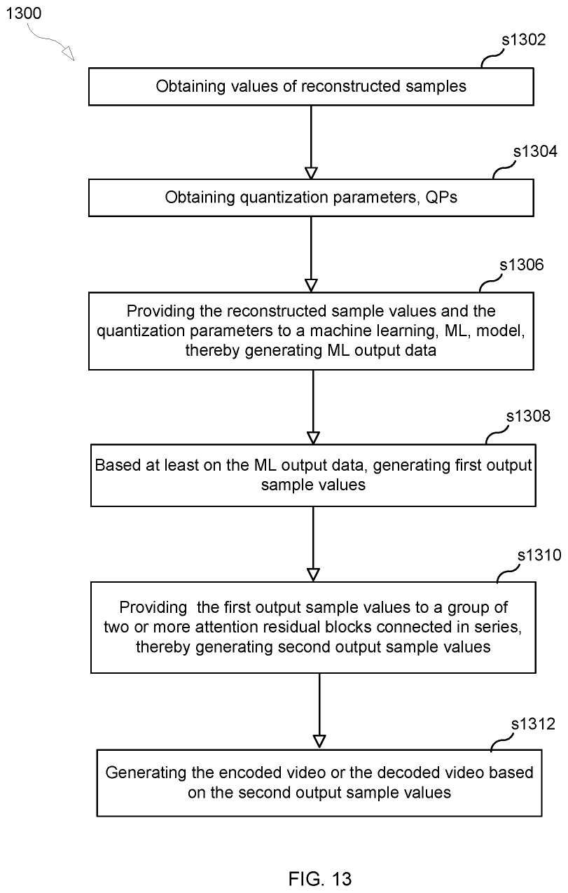

FIG. 13 shows a process 1300 for generating an encoded video or a decoded video. The process 1300 may begin with step s1302. Step s1302 comprises obtaining values of reconstructed samples. Step s1304 comprises obtaining quantization parameters, QPs. Step s1306 comprises providing the reconstructed sample values and the quantization parameters to a machine learning, ML, model, thereby generating ML output data. Step s1308 comprises based at least on the ML output data, generating (s1308) first output sample values. Step s1310 comprises providing the first output sample values to a group of two or more attention residual blocks connected in series, thereby generating second output sample values. Step s1312 comprises generating the encoded video or the decoded video based on the second output sample values. The group of attention residual blocks comprises a first attention residual block disposed at one end of the series of attention residual blocks, and the first attention residual block is configured to receive input data consisting of the first output sample values and the QPs.

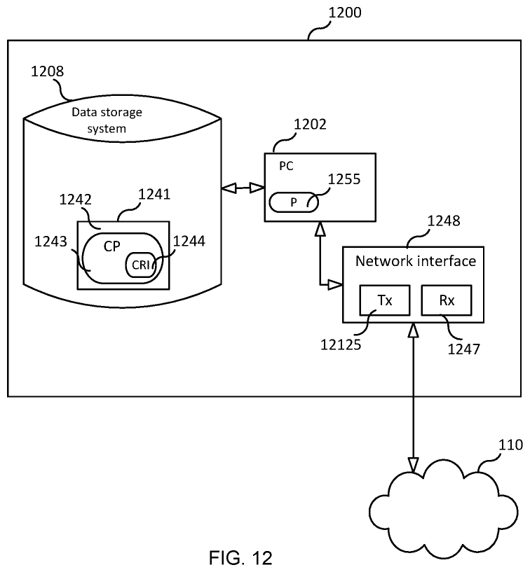

FIG. 12 is a block diagram of an apparatus 1200 for implementing the encoder 112, the decoder 114, or a component included in the encoder 112 or the decoder 114 (e.g., the NN filter 280 or 330), according to some embodiments. When apparatus 1200 implements a decoder, apparatus 1200 may be referred to as a “decoding apparatus 1200,” and when apparatus 1200 implements an encoder, apparatus 1200 may be referred to as an “encoding apparatus 1200.” As shown in FIG. 12, apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); at least one network interface 1248 comprising a transmitter (Tx) 1245 and a receiver (Rx) 1247 for enabling apparatus 1200 to transmit data to and receive data from other nodes connected to a network 110 (e.g., an Internet Protocol (IP) network) to which network interface 1248 is connected (directly or indirectly) (e.g., network interface 1248 may be wirelessly connected to the network 110, in which case network interface 1248 is connected to an antenna arrangement); and a storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

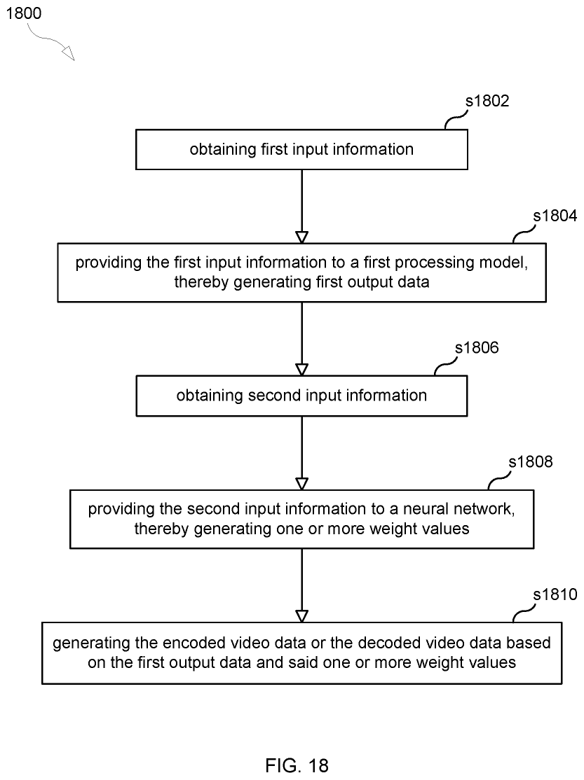

FIG. 18 shows a process 1800 for generating encoded video data or decoded video data according to some embodiments. Process 1800 may begin with step s1802. Step s1802 comprises obtaining first input information, wherein the first input information comprises any one or more of the following parameters: i) values of reconstructed samples; ii) values of predicted samples; iii) partition information indicating how samples are partitioned; iv) block boundary strength, BS, information indicating strength of filtering applied to samples at a boundary; v) one or more quantization parameters, QPs; vi) values of deblocked samples or vii) information about prediction indicating a prediction mode. Step s1804 comprises providing the first input information to a first processing model, thereby generating first output data. Step s1806 comprises obtaining second input information, wherein the second input information comprises any one or more of the following parameters: i) the values of reconstructed samples; ii) the values of predicted samples; iii) the partition information; iv) the BS information; v) said one or more QPs; or vi) the values of deblocked samples. Step 1808 comprises providing the second input information to a neural network, thereby generating one or more weight values. Step s1810 comprises generating the encoded video data or the decoded video data based on the first output data and said one or more weight values.

In some embodiments, said one or more weight values are for performing a channel-wise attention operation.

In some embodiments, the parameters included in the first input information and the parameters included in the second input information do not overlap.

In some embodiments, the parameters included in the first input information and the parameters included in the second input information at least partially overlap.

In some embodiments, the second input information consists of said one or more QPs.

In some embodiments, the method comprises generating residual data based on input data; multiplying the residual data by the first output data, thereby generating multiplication data; and generating second output data based on the multiplication data and said one or more weight values, wherein the encoded video data or the decoded video data is generated based on the second output data.

In some embodiments, the second output data is generated based on multiplying the multiplication data by said one or more weight values.

In some embodiments, z0=(r×f×w)+r+y, where z0 is the second output data, f is the first output data, r is the residual data, w is said one or more weight values, and y is the input data.

In some embodiments, the second output data is generated based on adding the multiplication data to the residual data and multiplying a result of the addition of the multiplication data and the residual data by said one or more weight values.

In some embodiments, z0=((r×f)+r)×w+y, where z0 is the second output data, f is the first output data, r is the residual data, w is said one or more weight values, and y is the input data.

In some embodiments, the second output data is generated based on adding to the multiplication data the residual data and the input data.

In some embodiments, z0=((r×f)+r+y)×w, where z0 is the second output data, f is the first output data, r is the residual data, w is said one or more weight values, and y is the input data.

In some embodiments, the method comprises generating residual data based on input data and said one or more weight values; multiplying the residual data by the first output data, thereby generating multiplication data, wherein the encoded video data or the decoded video data is generated based on the multiplication data.

In some embodiments, the method comprises providing the input data to a first convolution neural network, CNN, thereby generating first convoluted data; and multiplying the first convoluted data by said one or more weight values, wherein the residual data is generated based on the multiplication of the first convoluted data and said one or more weight values.

In some embodiments, the method comprises providing the first convoluted data to a first parametric rectified linear unit, PRELU, and a second CNN coupled to the first PRELU, thereby generating second convoluted data; and multiplying the second convoluted data by said one or more weight values, wherein the residual data is generated based on the multiplication of the second convoluted data and said one or more weight values.

In some embodiments, the first processing model comprises: a first concatenating layer for concatenating the first input information; a first model CNN coupled to the first concatenating layer; a first model PRELU coupled to the first model CNN; and a second model CNN coupled to the first model PReLU.

In some embodiments, the NN model comprises: a second concatenating layer for concatenating the second input information; a third model CNN coupled to the second concatenating layer; a second model PRELU coupled to the second model CNN; and a fourth model CNN coupled to the second model PRELU.

In some embodiments, the NN model is a multilayer perceptron NN.

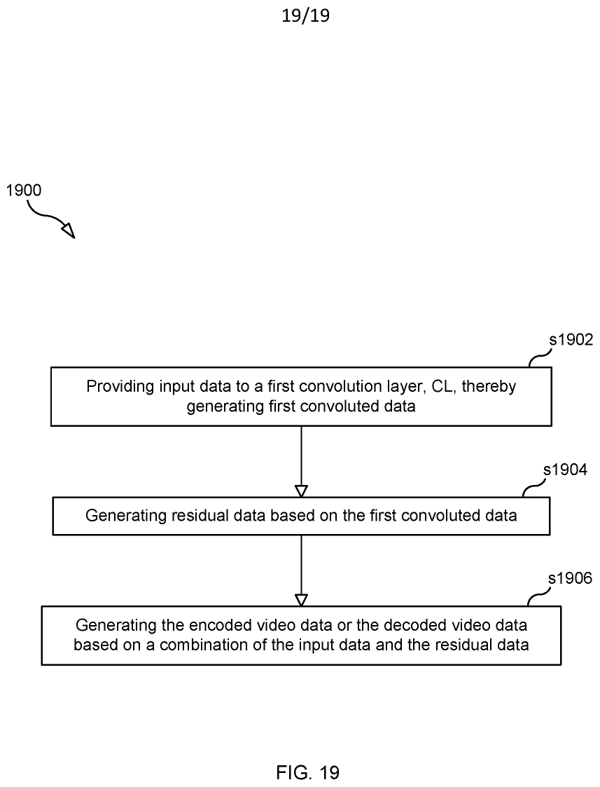

FIG. 19 shows a process 1900 of generating encoded video data or decoded video data, according to some embodiments. The process 1900 may begin with step s1902. The step s1902 comprises providing input data to a first convolution layer, CL, thereby generating first convoluted data. Step s1904 comprises generating residual data based on the first convoluted data. Step s1906 comprises generating the encoded video data or the decoded video data based on a combination of the input data and the residual data.

In some embodiments, the combination of the input data and the residual data is a sum of the input data and the residual data.

In some embodiments, the sum of the input data and the residual data comprises r+y, where r is a residual value included in the residual data and y is an input value included in the input data.

In some embodiments, the sum of the input data and the residual data is a weighted sum of the input data and the residual data.

In some embodiments, the process 1900 comprises obtaining input information that comprises any one or more of the following parameters: i) values of reconstructed samples; ii) values of predicted samples; iii) partition information indicating how samples are partitioned; iv) block boundary strength, BS, information indicating strength of filtering applied to samples at a boundary; v) one or more quantization parameters, QPs; vi) values of deblocked samples; and providing the input information to a neural network, NN, model, thereby generating one or more weight values, wherein the encoded video data or the decoded video data is generated based on said one or more weight values.

In some embodiments, the input information consists of said one or more QPs.

In some embodiments, said one or more weight values are for performing a channel-wise attention operation.

In some embodiments, the NN model comprises: a concatenating layer for concatenating the input information, a CL coupled to the concatenating layer, a parametric rectified linear unit, PRELU, coupled to the CL that is coupled to the concatenating layer, and a CL coupled to the PRELU.

In some embodiments, the NN model is a multilayer perceptron NN.

In some embodiments, the encoded video data or the decoded video data is generated based on the weighted sum of the input data and the residual data, and the weight sum of the input data and the residual data comprises w×r+y, where w is one of said one or more weight values, r is a residual value included in the residual data, and y is an input value included in the input data.

In some embodiments, the encoded video data or the decoded video data is generated based on the weighted sum of the input data and the residual data, and the weight sum of the input data and the residual data comprises w×(r+y), where w is one of said one or more weight values, r is a residual value included in the residual data, and y is an input value included in the input data.

In some embodiments, the process 1900 comprises providing the first convoluted data into a parametric rectified linear unit, PRELU, coupled to the first CL, thereby generating rectified data; providing the rectified data into a second CL, thereby generating second convoluted data, wherein the second convoluted data is the residual data.

In some embodiments, the process 1900 comprises multiplying the first convoluted data by said one or more weight values, thereby generating weighted first convoluted data, wherein the residual data is generated based on the multiplication of the weighted first convoluted data.

In some embodiments, the process 1900 comprises providing the weighted first convoluted data to a PRELU, thereby generating rectified data; providing the rectified data to a second CL, thereby generating second convoluted data; and multiplying the second convoluted data by said one or more weight values, wherein the residual data is generated based on the multiplication of the second convoluted data by said one or more weight values.

### Summary of Some Embodiments

A1. A method (1800) of generating encoded video data or decoded video data, the method comprising:
obtaining (s1802) first input information (e.g., rec, pred, part, bs, qp, dblk), wherein the first input information comprises any one or more of the following parameters: i) values of reconstructed samples; ii) values of predicted samples; iii) partition information indicating how samples are partitioned; iv) block boundary strength, BS, information indicating strength of filtering applied to samples at a boundary; v) one or more quantization parameters, QPs; vi) values of deblocked samples; vii) information about prediction indicating a prediction mode; or; viii) skip-mode information indicating if a block is a skip-block;
providing (s1804) the first input information to a first processing model (e.g., spatial attention block), thereby generating first output data (e.g., f);
obtaining (s1806) second input information (e.g., rec, pred, part, bs, qp, dblk), wherein the second input information comprises any one or more of the following parameters: i) the values of reconstructed samples; ii) the values of predicted samples; iii) the partition information; iv) the BS information; v) said one or more QPs; or vi) the values of deblocked samples;
providing (s1808) the second input information to a neural network, (e.g., NN), thereby generating one or more weight values (e.g., one or more channel-wise attention weight values); and
generating (s1810) the encoded video data or the decoded video data based on the first output data (e.g., f) and said one or more weight values (e.g., the output of NN “w”).

A1a. The method of embodiment A1, wherein said one or more weight values are for performing a channel-wise attention operation.

A2. The method of embodiment A1, wherein the parameters included in the first input information and the parameters included in the second input information do not overlap.

A3. The method of embodiment A1, wherein the parameters included in the first input information and the parameters included in the second input information at least partially overlap.

A4. The method of any one of embodiments A1-A3, wherein the second input information consists of said one or more QPs.

A5. The method of any one of embodiments A1-A4, comprising:
generating residual data (e.g., r) based on input data (e.g., y);
multiplying the residual data (e.g., r) by the first output data (e.g., f), thereby generating multiplication data (e.g., r×f); and
generating second output data (e.g., z₀) based on the multiplication data (e.g., r×f) and said one or more weight values, wherein
the encoded video data or the decoded video data is generated based on the second output data.

A6. The method of embodiment A5, wherein the second output data (e.g., z0) is generated based on multiplying the multiplication data (e.g., r×f) by said one or more weight values (e.g., w).

A7. The method of embodiment A6, wherein z0=(r×f×w)+r+y, where z0 is the second output data, f is the first output data, r is the residual data, w is said one or more weight values, and y is the input data.

A8. The method of embodiment A5, wherein the second output data (e.g., z0) is generated based on adding the multiplication data (e.g., r×f) to the residual data (e.g., r) and multiplying a result of the addition of the multiplication data and the residual data by said one or more weight values (e.g., w).

A9. The method of embodiment A8, wherein z0=((r×f)+r)×w+y, where z0 is the second output data, f is the first output data, r is the residual data, w is said one or more weight values, and y is the input data.

A10. The method of embodiment A5, wherein the second output data (e.g., z0) is generated based on adding to the multiplication data (e.g., r×f) the residual data (e.g., r) and the input data (e.g., y).

A11. The method of embodiment A10, wherein z0=((r×f)+r+y)×w, where z0 is the second output data, f is the first output data, r is the residual data, w is said one or more weight values, and y is the input data.

A12. The method of any one of embodiments A1-A4 comprising:
generating residual data (e.g., r) based on input data (e.g., y) and said one or more weight values (e.g., w);
multiplying the residual data (e.g., r) by the first output data (e.g., f), thereby generating multiplication data (e.g., r×f), wherein
the encoded video data or the decoded video data is generated based on the multiplication data (e.g., r×f).

A13. The method of embodiment A12, comprising:
providing the input data (e.g., y) to a first convolution neural network, CNN, (e.g., conv3×3), thereby generating first convoluted data; and
multiplying the first convoluted data by said one or more weight values, wherein
the residual data is generated based on the multiplication of the first convoluted data and said one or more weight values.

A14. The method of embodiment A13, comprising:
providing the first convoluted data to a first parametric rectified linear unit, PRELU, and a second CNN coupled to the first PRELU, thereby generating second convoluted data; and
multiplying the second convoluted data by said one or more weight values, wherein
the residual data is generated based on the multiplication of the second convoluted data and said one or more weight values.

A15. The method of any one of embodiments A1-A14, wherein the first processing model comprises:
a first concatenating layer for concatenating the first input information;
a first model CNN coupled to the first concatenating layer;
a first model PRELU coupled to the first model CNN; and
a second model CNN coupled to the first model PRELU.

A16. The method of embodiment A15, wherein the NN model comprises:
a second concatenating layer for concatenating the second input information;
a third model CNN coupled to the second concatenating layer;
a second model PRELU coupled to the second model CNN; and
a fourth model CNN coupled to the second model PReLU.

A17. The method of any one of embodiments A1-A14, wherein the NN model is a multilayer perceptron NN.

B1. A computer program (1243) comprising instructions (1244) which when executed by processing circuitry (1202) cause the processing circuitry to perform the method of any one of embodiments A1-A17.

B2. A carrier containing the computer program of embodiment B1, wherein the carrier is one of an electronic signal, an optical signal, a radio signal, and a computer readable storage medium.

C1. An apparatus (1200) for generating encoded video data or decoded video data, the apparatus being configured to:
obtain (s1802) first input information (e.g., rec, pred, part, bs, qp, dblk), wherein the first input information comprises any one or more of the following parameters: i) values of reconstructed samples; ii) values of predicted samples; iii) partition information indicating how samples are partitioned; iv) block boundary strength, BS, information indicating strength of filtering applied to samples at a boundary; v) one or more quantization parameters, QPs; vi) values of deblocked samples or vii) information about prediction indicating a prediction mode;
provide (s1804) the first input information to a first processing model (e.g., spatial attention block), thereby generating first output data (e.g., f);
obtain (s1806) second input information (e.g., rec, pred, part, bs, qp, dblk), wherein the second input information comprises any one or more of the following parameters: i) the values of reconstructed samples; ii) the values of predicted samples; iii) the partition information; iv) the BS information; v) said one or more QPs; or vi) the values of deblocked samples;
provide (s1808) the second input information to a neural network, (e.g., NN), thereby generating one or more weight values (e.g., one or more channel-wise attention weight values); and
generate (s1810) the encoded video data or the decoded video data based on the first output data (e.g., f) and said one or more weight values (e.g., the output of NN “w”).

C2. The apparatus of embodiment C1, wherein the apparatus is configured to perform the method of at least one of embodiments A2-A17.

D1. An apparatus (1200) comprising:
a processing circuitry (1202); and
a memory (1241), said memory containing instructions executable by said processing circuitry, whereby the apparatus is operative to perform the method of at least one of embodiments A2-A17.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-19. (canceled)

20. A method of generating encoded video data or decoded video data in a neural network comprising a first group of layers for receiving inputs, a chain of one or more residual blocks, and a second group of layers for generating an output, wherein at least a first residual block in the chain of one or more residual blocks comprises a multilayer perceptron network, the method comprising:
the first group of layers receiving the inputs and generating a first block representation input data;
the chain of one or more residual blocks receiving and using the first block representation input data to generate a last block representation output data; and
the second group of layers receiving and using the last block representation output data to generate the encoded video data or the decoded video data, wherein
the chain of one or more residual blocks generates the last block representation output data by performing a method comprising:
the first residual block receiving and using the generated first block representation input data from the first group of layers and using the multilayer perceptron network to generate a block residual data and to use a combination of the received first block representation input data and the block residual data to generate a block representation output data; and
a next residual block of the chain of residual blocks receiving and using the block representation output data as block representation input data to generate next block representation output data or, if the last residual block of the chain of residual blocks, to generate the last block representation output data.

21. The method of claim 20, wherein the combination of the block representation input data and the block residual data is a sum of the input data and the residual data.

22. The method of claim 21, wherein the sum of the input data and the residual data comprises r+y, where r is a residual value included in the residual data and y is an input value included in the input data.

23. The method of claim 21, wherein the sum of the input data and the residual data is a weighted sum of the input data and the residual data.

24. The method of claim 20, the method comprising:
obtaining input information that comprises any one or more of the following parameters: i) values of reconstructed samples; ii) values of predicted samples; iii) partition information indicating how samples are partitioned; iv) block boundary strength, BS, information indicating strength of filtering applied to samples at a boundary; v) one or more quantization parameters, QPs; vi) values of deblocked samples; and
providing the input information to a neural network, NN, model, thereby generating one or more weight values, wherein
the encoded video data or the decoded video data is generated based on said one or more weight values.

25. The method of claim 24, wherein said one or more weight values are for performing a channel-wise attention operation.

26. The method of claim 24, wherein the NN model comprises:
a concatenating layer for concatenating the input information,
a CL coupled to the concatenating layer,
a parametric rectified linear unit, PRELU, coupled to the CL that is coupled to the concatenating layer, and
a CL coupled to the PRELU.

27. The method of claim 24, wherein the NN model is a multilayer perceptron NN.

28. The method of claim 24, wherein
the encoded video data or the decoded video data is generated based on the weighted sum of the input data and the residual data, and
the weight sum of the input data and the residual data comprises w×r+y, where w is one of said one or more weight values, r is a residual value included in the residual data, and y is an input value included in the input data.

29. The method of claim 24, wherein
the encoded video data or the decoded video data is generated based on the weighted sum of the input data and the residual data, and
the weight sum of the input data and the residual data comprises w×(r+y), where w is one of said one or more weight values, r is a residual value included in the residual data, and y is an input value included in the input data.

30. The method of claim 24, comprising:
multiplying the first convoluted data by said one or more weight values, thereby generating weighted first convoluted data, wherein
the residual data is generated based on the multiplication of the weighted first convoluted data.

31. The method of claim 30, comprising:
providing the weighted first convoluted data to a PReLU, thereby generating rectified data;
providing the rectified data to a second CL, thereby generating second convoluted data; and
multiplying the second convoluted data by said one or more weight values, wherein
the residual data is generated based on the multiplication of the second convoluted data by said one or more weight values.

32. The method of a claim 20, the method comprising:
providing the first convoluted data into a parametric rectified linear unit, PRELU, coupled to the first CL, thereby generating rectified data;
providing the rectified data into a second CL, thereby generating second convoluted data, wherein
the second convoluted data is the residual data.

33. A non-transitory computer readable storage medium storing a computer program comprising instructions for configuring an apparatus comprising processing circuitry for executing the instructions to perform the method of claim 20.

34. An apparatus for generating encoded video data or decoded video data, the apparatus comprising:
a processing circuitry; and
a memory coupled to the processing circuitry, whereby the apparatus is configured to implement a neural network comprising a first group of layers including a first convolution layer, CL, a chain of one or more residual blocks, and a second group of layers for generating an output, wherein at least a first residual block in the chain of one or more residual blocks comprises a multilayer perceptron network, the apparatus being further configured:
to provide input data to the first group of layers thereby to generate first block representation input data comprising first convoluted data;
the chain of one or more residual blocks to receive and use the first convoluted data to generate a last block representation output data; and
the second group of layers to receive and use the last block representation output data to generate the encoded video data or the decoded video data,
wherein the chain of one or more residual blocks generates the last block representation output data by:
the first residual block receiving and using the first convoluted data and using the multilayer perceptron network to generate a block residual data and to use a combination of the received first convoluted data and the block residual data to generate a block representation output data; and
a next residual block of the chain of residual blocks receiving and using the block representation output data as block representation input data to generate next block representation output data or, if the last residual block of the chain of residual blocks, to generate the last block representation output data.

35. The apparatus of claim 34, wherein the combination of the block representation input data and the block residual data is a sum of the input data and the residual data.

36. The apparatus of claim 35, wherein the sum of the input data and the residual data comprises r+y, where r is a residual value included in the residual data and y is an input value included in the input data.

37. The apparatus of claim 35, wherein the sum of the input data and the residual data is a weighted sum of the input data and the residual data.

38. The apparatus of claim 34, being further configured to:
obtain input information that comprises any one or more of the parameters: i) values of reconstructed samples; ii) values of predicted samples; iii) partition information indicating how samples are partitioned; iv) block boundary strength, BS, information indicating strength of filtering applied to samples at a boundary; v) one or more quantization parameters, QPs; and vi) values of deblocked samples; and
provide the input information to a neural network, NN, model, thereby generating one or more weight values, wherein
the encoded video data or the decoded video data is generated based on said one or more weight values.

39. The apparatus of claim 38, wherein the NN model comprises:
a concatenating layer for concatenating the input information,
a CL coupled to the concatenating layer;
a parametric rectified linear unit, PRELU, coupled to the CL that is coupled to the concatenating layer; and
a CL coupled to the PRELU.

40. The apparatus of claim 38, wherein the NN model is a multilayer perceptron NN.

41. The apparatus of claim 38, being further configured to:
generate the encoded video data or the decoded video data based on the weighted sum of the input data and the residual data, wherein
the weight sum of the input data and the residual data comprises w×r+y, where w is one of said one or more weight values, r is a residual value included in the residual data, and y is an input value included in the input data.

42. The apparatus of claim 38, being further configured to:
generate the encoded video data or the decoded video data based on the weighted sum of the input data and the residual data, wherein
the weight sum of the input data and the residual data comprises w×(r+y), where w is one of said one or more weight values, r is a residual value included in the residual data, and y is an input value included in the input data.

43. The apparatus of claim 38, being further configured to:
multiply the first convoluted data by said one or more weight values, thereby generating weighted first convoluted data, wherein
the residual data is generated based on the multiplication of the weighted first convoluted data.

44. The apparatus of claim 43, being further configured to implement a parametric rectified linear unit, PRELU, coupled to the first CL, to implement a second CL, and to:
provide the weighted first convoluted data to the PRELU, thereby to generate rectified data;
provide the rectified data to the second CL, thereby to generate second convoluted data; and
multiply the second convoluted data by said one or more weight values, wherein
the residual data is generated based on the multiplication of the second convoluted data by said one or more weight values.

45. The apparatus of claim 34, being further configured to implement a parametric rectified linear unit, PRELU, coupled to the first CL, to implement a second CL, and to:
provide the first convoluted data into the PRELU thereby to generate rectified data;
provide the rectified data into the second CL, thereby generating second convoluted data, wherein
the second convoluted data is the residual data.
